(19) United States
(12) Patent Application Publication
(10) Pub. No.: US 2008/0077336 A1
(43) Pub. Date: Mar. 27, 2008

(54) Power line universal monitor

(76) Inventor: Roosevelt Fernandes, Chino Hills, CA (US)

Correspondence Address: ZUBER & TAILLIEU LLP, 10866 WILSHIRE BLVD., SUITE 300, LOS ANGELES, CA, 90024, US

(21) Appl. No.: 11/527,093

(22) Filed: Sep. 25, 2006

(51) Int. Cl. G06F 19/00

(52) U.S. Cl. 702/57; 340/870.01; 340/870.07; 702/1; 702/60; 702/64; 702/65; 702/189

(57) ABSTRACT

The invention is primarily directed to hot-stick mountable wireless High Voltage Power Line Universal Monitors (PLUM) upon energized electrical power conductors. The PLUM wireless sensors monitor parameters associated with normal, overload and emergency operation of the power line. The present invention provides 0.2% metering grade voltage measurement accuracy through unique e-field measurements, synchronized through UltraSatNet Global Positioning Satellite (GPS) accuracy timing pulses. The invention further improves accuracy using a unique calibration technique during initial installation of the PLUM sensor modules. A PLUM master controller receives time-synchronized data from multiple modules within a substation and across a state-wide power grid for accurate post-fault, sequence-of-events analysis, high impedance fault signature analysis, and environmental and earthquake monitoring.

### BACKGROUND OF THE INVENTION

Various power line mounted apparatus for sensing operating parameters of an associated conductor have been disclosed in the prior art. See, for example, U.S. Pat. Nos. 4,709,339; 3,428,896; 3,633,191; 4,158,810; and 4,261,818. In general, such systems include line-mounted sensor modules which measure certain quantities associated with operation of overhead power lines, namely, current, conductor temperature, ambient temperature, and limited voltage measurement accuracy due to various environmental and other factors. These sensors then transmit such data via a one-way radio link to a nearby ground station. Data from several ground stations is then transmitted to a central control station where it is processed and used to assist in control of the power supplied to the various transmission lines in accordance with the measured parameters.

Prior art systems of this type, while representing a significant improvement over traditional means of measurement and control of power line operating parameters, still have a number of inherent limitations and disadvantages. For example, prior art solutions suffer greatly in their ability to coordinate measurement and control over a wide spread area due to inherent accuracy limitations and timing delays caused in transmission. Other disadvantages of prior art systems include the shorting effect of snow and ice transitions across the hub, inability to provide hub capacitance flexibility to use the sensor for voltage measurements over the full range from 4.8 kV to 500 kV, inability to prevent hacker interference with communications between the sensor and the base station, and inability to establish phase between wireless sensors located tens to hundreds of miles apart.

### SUMMARY OF THE INVENTION

In the present invention, a Power Line Universal Monitor (PLUM) and a Master Controller, (referred to as the PLUM System) are suitable for a wide range of power system monitoring and control applications in the high voltage conductor environment of transmission lines and substations. The PLUM system is unique in its ability to provide accurate measurements for:
Fault Identification, Fault Isolation and Service Restoration using Supervisory Control And Data Acquisition (SCADA) 2-way communications
Auto Recloser operation count
SCADA VoltageNAR Control/Capacitor switching
Insulated Conductor Burn-Down Fault Isolation Relay i.e High impedance fault detection
Demand Control
Metering Gateway
Phasor Measurements
Weather Station
Power Quality
Dynamic Line Ratings
Differential Relay Protection
Earth Quake monitoring

The present invention advances the state-of-the-art in high voltage conductor universal monitoring and control by improving wireless hot-stick mountable sensors in the following areas:
Greater accuracy of voltage measurement through multiple capacitors created between the sensor housing and the high voltage conductor allowing, parallel, series, or series-parallel connections depending on the voltage class.
The PLUM wireless sensor configuration allows 0.2% metering grade voltage accuracy measurement for 4.8 kV to 500 kV high voltage lines even during inclement weather conditions.
Provides means for synchronizing the wireless sensors across the entire grid at a regional or national level using an UltraSatNet Ultra Small Antenna Terminal (USAT) satellite network for measurement synchronization using IRIG-B level accuracy, or using local GPS derived synch pulses.
Permits accurate time-synchronized data acquisition from multiple modules across the Power Grid covering thousands of square miles for accurate post-fault, sequence-of-events analysis.
Uses high speed sampling and harmonic content variation and transient randomness comparison of cyclically variable parameters for relaying measurement applications.
Uses high speed sampling of the current and voltage measurement to provide harmonic measurements to the highest order exceeding the 33^{rd} for signature analysis in identifying high impedance faults.
Measures voltage and current phase angles to an accuracy better than 0.01 degrees for synchro-phasor measurements
Provides means for detecting high impedance distribution circuit ground faults. Establishes distance between the fault and its own location using traveling wave reflection at the fault.
Keeps track of distribution circuit auto re-closer operation for transmission to a power dispatch control center operator or to a service crew.
Provides GPS accuracy geographic and electrical circuit synchronized snap shot data for power grid voltageNAR control and efficient service restoration following system emergencies.
Provides accurate metering data that can be compared with gateway automatic meter readings to detect area outages down to the customer level.
Provides accurate measurement of power quality.
Measures ambient air temperature and conductor temperature more accurately without influencing the conductor temperature measurement by blocking air flow. Prior art temperature measurements were affected by the configuration of the wireless sensor temperature measurement probes and the housing itself. This resulted in inaccurate dynamic line rating measurements.
The present invention improves the differential protection accuracy.
The Weather Station PLUM in addition to the normal weather sensors uses a Piezzo vibration sensor and digital filters to distinguish between conductor vibrations and earth quake induced vibrations to detect propagation of the ground motion, amplified by the towers and overhead lines, emanating from the epicenter.
The wireless PLUM sensors are provided with space and time encoding to avoid susceptibility to hacking or inadvertent control commands being introduced into the power grid control system.
A method to accurately calibrate the voltage measurement system during installation is another aspect of the invention.
The PLUM provides accurate phasor measurements to an angular accuracy better than 0.01 degrees. This provides a hitherto unattained accuracy for state estimators used in stability analysis of the power grid.
Uses a mini-video cam to monitor physical switch open-close conditions before and after an operate command from the Supervisory Control And Data Acquisition (SCADA) Master.
Interrogates downstream and upstream PLUM's to establish faulted feeder segment.
Injects Power Line Carrier (PLC) to communicate to other sensors or a fiber optic link if an RF channel is not available and to measure feeder impedance characteristics and load dynamics.

### BRIEF DESCRIPTION OF THE DRAWINGS

FIG. 1 is a perspective view of the wireless sensor module of the invention for two-way synchronized communications via satellite links, single hot-stick mounted on each phase conductor of a live three phase high voltage electric power line;

FIG. 2 is a perspective view of a sensor module embodying the present invention showing the opposite end view with the air and conductor temperature sensors visible;

FIG. 3 is a longitudinal perspective of the sensor module showing the current sensor, rechargeable battery, and power supply;

FIG. 4 is a cross-sectional view of the sensor module of FIGS. 1-3 showing the hub voltage sensor arrangement, dielectric junction, and conductor braided contacts made through the hub rubberized insulating rings forming a cylindrical capacitor with a large surface contact area. Also shows free air passage through the hub and the open-close actuating mechanism;

FIG. 5 shows the PLUM wireless sensor in the open position exposing the voltage sensor for increased accuracy for the entire high voltage range from 4.8 kV to 500 kV through series or series parallel connections of four or more hub capacitors providing greater sensitivity for a particular distribution or transmission voltage and calibration accuracy;

FIG. 6 is a top cross-sectional view of a PLUM, exposing the laminated power supply core, rechargeable battery loop, Rogowski current coil and four hub capacitors separated by insulating rings;

FIG. 7 shows a couple of the many possible electrical connections of the hub capacitors in a PLUM for maximum voltage measurement accuracy;

FIG. 8 is an exploded view of a PLUM including the sensors and construction of the four hub capacitors from individual concentric ring assemblies consisting of a hub housing adaptor metal ring separated from a second concentric metallic ring with a dielectric material, and a suitable conductor gripping material with a braided conductor making contact between the conductor and inner capacitor ring;

FIG. 9 is an exploded view of a PLUM showing the iron core and coil with a molded surge suppression element and the insulating separators used between the assembled capacitors;

FIG. 10 shows the assembly of PLUM and in particular the laminated core and molded coil with surge protection;

FIG. 11 displays the PLUM Electronics Architecture block diagram for the Power Supply with split core Current Transformer Input; Sensor I/O and A/D Processing, Micro-Processor Controller, and Wireless Transceiver for RF spread spectrum communications to a pole-top Master Controller;

FIG. 12 displays the block diagram for the power supply, microprocessor controller, data multiplexer, sensor A/D conversion, data storage & synchronizing logic board; 900 MHz or higher frequency RF spread spectrum communications transceiver board for serial data communication to a pole-top Master Controller;

FIG. 13 illustrates the concept of a PLUM Pole-Top Master Controller providing two-way communications between the conductor mounted PLUM wireless sensor modules to synchronize data acquisition between PLUMs locally and across a power grid through the co-located UltraSatNet terminal;

FIG. 14 shows a Master Controller combined with a substation RTU to acquire synchronized serial digital data stream from the PLUM sensors for transmission to the SCADA Master via a remote monitoring and control communications link;

FIG. 15 shows a block diagram for high impedance fault detection signature analysis using a conductor mounted PLUM;

FIG. 16 illustrates a hot-stick mountable calibration PLUM for on-site PLUM sensor calibration;

FIG. 17 illustrates a schematic block diagram for a Gateway PLUM for Automatic Meter Reading using a Local Area Network RF link to meters or for communication to local area sensors for earth quake accelerometer sensor monitoring;

FIG. 18 illustrates a schematic block diagram for Power Line Carrier/radio communication between PLUMs located at other pole-top locations for fault detection, isolation and service restoration along a feeder or transmission line;

FIG. 19 illustrates the concept of using a PLUM for AMR/Customer Non-Critical Load Control;

FIG. 20 illustrates a schematic block diagram for Coordinated VAR Control or synchronized remote switch operation using PLUM;

FIG. 21 shows a block diagram of the PLUM for Video and Infra-red Monitoring System for Remote Switch Position Visual Display and Pole-Top Transformer Temperature Monitoring;

FIG. 22 shows a block diagram of the PLUM Video Link;

FIG. 23 shows a schematic block diagram for a conductor mounted PLUM Weather Station & Earth Quake Monitoring System;

FIG. 24 shows the basic Communication Message Format Envelope between a PLUM and a Master Controller;

FIG. 25 illustrates a preferred General Message Data Format for communications between a PLUM and a Master Controller;

FIG. 26 illustrates the Command Byte Master Controller to PLUM Message Request Format;

FIG. 27 shows the PLUM Status Byte for the PLUM to Master Controller reply Message;

FIG. 28 shows the Message Format for a Master to PLUM Scan 1 Request, PLUM to Master Scan 1 reply Message, and PLUM to Master Controller Scan Reply Header including multiple data blocks; and

FIG. 29 illustrates a preferred embodiment for a Dielectric Fiber Optic Link between a PLUM and a Master Controller.

### DETAILED DESCRIPTION

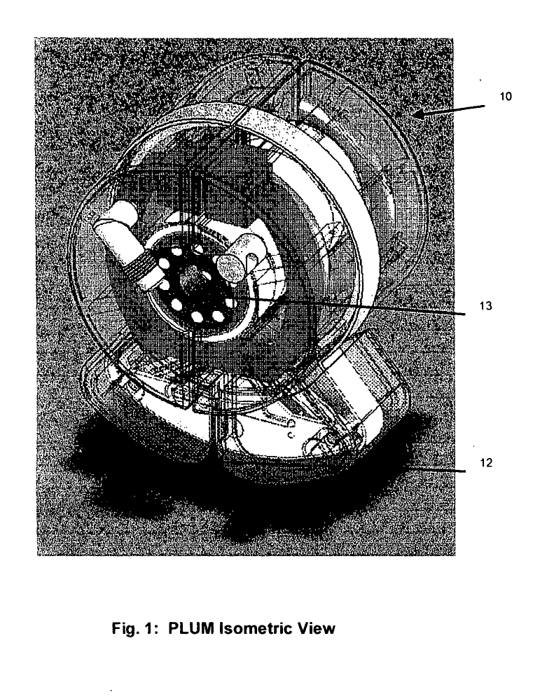

This invention discloses a unique high voltage conductor mounted sensor which is referred to as a Power Line Universal Monitor (PLUM), as shown in FIG. 1. The sensor is inductively powered off the high voltage conductor line, and is used to measure current and voltage in a synchronized fashion over a wide area power grid network for high voltage power grid metering, Supervisory Control And Data Acquisition (SCADA), transmission & distribution automation, fault identification, sequence-of-events detection, relaying and other applications. The PLUM is designed for single hot stick mounting on energized power line conductors for voltages up to 500 kV. The PLUM derives its power from the current flowing through the energized power conductor. Internal rechargeable batteries allow circuit monitoring even when the conductor current is interrupted.

The PLUM accurately measures all the power flow parameters during normal, abnormal and transient conditions. More important, the GPS synchronized data measurements through an UltraSatNet system allows sequence of events over a Synchronized Wide Area Network (SWAN). The basic PLUM measures GPS synchronized conductor RMS current, RMS voltage, frequency, phase angle, power factor, real power, reactive power, apparent power, and harmonics. High speed simultaneous sampling of the current and voltage and measurement of harmonic content also provides the capability to detect high impedance fault currents based on waveform signature analysis of voltage and current. For heavily loaded lines the PLUM is configured to measure conductor temperature and air temperature.

1.0 Introduction

As explained herein, the PLUM is designed for single hot stick mounting on energized power line conductors for voltages up to 500 kV. The PLUM derives its power from the current flowing through the energized power conductor. Internal rechargeable batteries allow circuit monitoring even when the conductor current is interrupted.

The PLUM is capable of accurate wide area GPS synchronized measurements of all the power flow parameters during normal, abnormal and transient conditions. The basic PLUM can be used to measure conductor RMS current, RMS voltage, frequency, phase angle, power factor, real power, reactive power, apparent power, and harmonics. Samples of the current and voltage also provide the capability to detect high impedance fault currents based on waveform signature analysis and randomness of voltage and current harmonics. For heavily loaded lines the PLUM can be configured to measure conductor temperature and air temperature.

The PLUM is powered electromagnetically using the power conductor current as the energy source with battery backup. The PLUM contains a wireless transmitter and receiver preferably designed to operate at a frequency of 900 MHz or higher. The wireless communications are fully GPS synchronized across a power grid through two way communications via Ultra Small Antenna Terminal (USAT) Intelligent Satellite links. The PLUM includes sensor modules, designed to monitor and control other devices in a cluster arrangement surrounding individual conductor mounted sensor modules. This includes automatic meter reading, demand control switches, earthquake sensors, and a variety of early warning sensors.

In normal operation the PLUM continuously monitors all the line parameters and transmits data when polled by the Master Controller via two-way communications over a wide area network. More specifically, the PLUM transmits any requested data set called for by the Master Controller over the wide area network. Alternatively, and in the case of fault identification (or other event driven function) the PLUM will automatically report the event immediately to the Master Controller, without waiting to be polled or requested to do so. The local SCADA link could be a USAT Remote unit in communication with the PLUM Master Controller and the satellite network Hub.

The PLUM uses a variety of sensors in the basic module. The conductor current is measured to a 0.1% accuracy preferably using a precision Rogowski Coil Current Transducer and state-of-the-art Analog Devices digital integrator and processing circuitry. The conductor voltage to ground is determined by measuring the E-field charging current. Final calibration is done at the time of installation of the PLUM in its final conductor position, next to the conductor insulator string. Voltage accuracy is assured by measurement through weather shielded, large surface area coaxial tubular hub capacitor formed by separating the concentric metallic cylinders with thin plasma coating of a ceramic or quartz dielectric with a high dielectric constant. The inner metallic surface of the hub capacitor is connected to the power conductor and the outer tubular metallic surface of the capacitor is connected to the PLUM metallic housing, through e-field charge current measurement circuitry. Four stacked metallic inner and outer metallic rings with the inner rings plasma coated and the stacks separated by four insulating rings allows for series and parallel connections of a plurality of hub capacitors in order to achieve the desired voltage measurement sensitivity.

A one-wire bus for temperature sensing allows use of multiple temperature sensors to meet requirements. The conductor temperature can be measured by a non-contact infra-red sensor or an IC chip based temperature contact sensor. The air temperature is measured using a non-contact RTD type probe.

Current and voltage waveforms are generated by high speed sampling of the 60 Hz signals to generate the highest waveform harmonic frequency component to be measured. This is accomplished using Fast Fourier Transform computations in conjunction with the A/D processor. An Analog Devices single phase metering device can also be used to process the input from the PLUM sensors The over-sampling required is essentially governed by the highest harmonic that needs to be captured. This processing is done in a micro-controller or DSP that can handle the maximum sampling rate dictated by the highest harmonics to be measured and the rise time of transient measurements to be made, including lightning transients. Details to accomplish these PLUM features are described in the following paragraphs.

Referring to FIG. 1, there is shown a 3D isometric view of the PLUM 10 FIG. 1 which is mounted on a high voltage conductor by inserting a hot-stick tool at 12 to snap the PLUM around the conductor passing through the split hub insert at 13. FIG. 1.

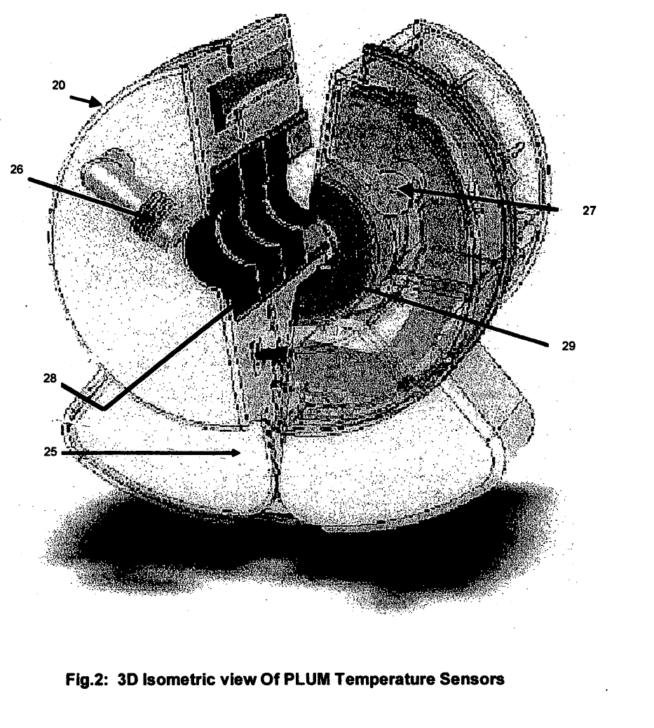

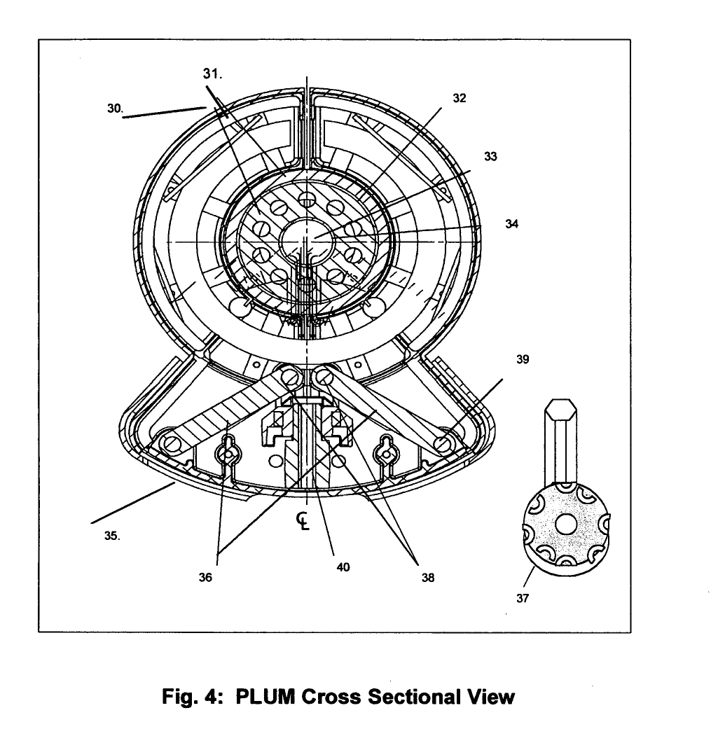

FIG. 2 shows an exploded view of the 4 section cylindrical cast aluminum housing with a fish-tail drive mechanism housing 25 shrouded in an insulating high strength, high temperature plastic casing 35 (FIG. 4). The PLUM “hub insert” inner split metallic ring 30 (FIG. 4) has a thickness preferably selected to allow a snug fit of the sensor module around the high voltage power conductor 33 (FIG. 4). The PLUM further includes a split rubberized cylindrical insert 34 FIG. 4 that surrounds the conductor.

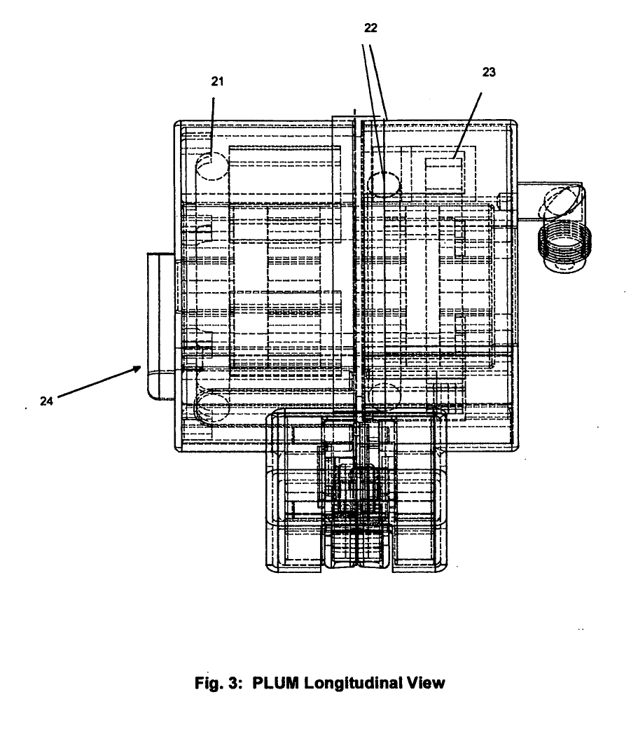

As explained earlier, the PLUM preferably includes a patch antenna 24 (FIG. 3) transmitter/receiver for RF communications. The signals from the PLUM are transmitted via a two-way 900 MHz radio, fiber optic or laser communication link to a Master Controller. In a PLUM system, a plurality of PLUMs may be mounted throughout a substation or power grid and will communicate with one or more Master Controllers depending on the application.

In a preferred embodiment, a PLUM 10 is removeably mounted directly upon each phase of an energized power line to sense and measure various parameters, including environmental parameters, associated with operation of the power grid. The cast segments are arranged to allow the drive mechanism 25 (FIG. 2), enclosed in cast aluminum housing segments insulated below the cylindrical split sections that snap around the high voltage conductor, and actuated by a hot-stick tool 37. An Allen wrench type hot-stick tool attachment 37 engages the drive cylinder 40 (FIG. 4), to open and close the PLUM module around the energized high voltage conductor. The PLUM Hub opening 13 (FIG. 1) where the left and right sections come together, when the hot-stick tool has been fully inserted with a cork-screw motion, accommodates various high voltage conductor diameters on which the PLUM is to be mounted. The hot-stick tool does not disengage from the PLUM until the sensor module is completely snapped shut around the conductor.

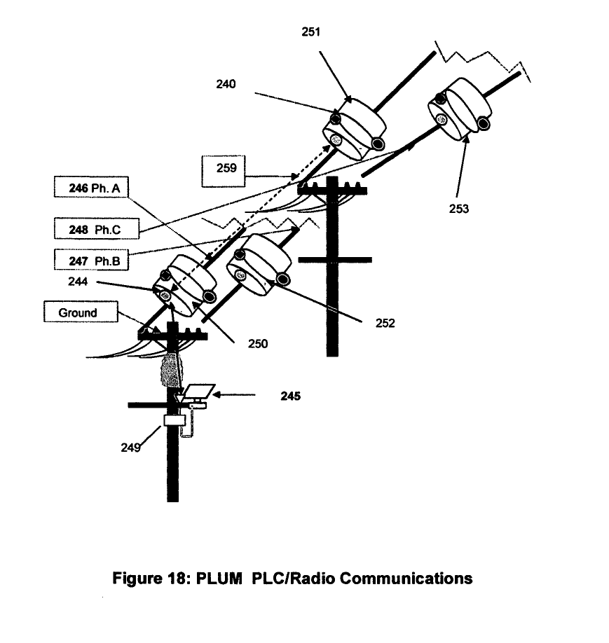

The PLUM is powered electromagnetically using the power conductor current as the energy source with battery backup. The PLUM contains a wireless transmitter and receiver typically operating at 900 MHz, 800 MHz or higher frequencies. The wireless communications are fully GPS synchronized across the power grid through two way communications via Ultra Small Antenna Terminal (USAT) intelligent satellite links. The sensor modules are also designed to monitor and control other devices in a cluster arrangement surrounding individual conductor mounted PLUM sensor modules through short haul two-way RF communications (FIG. 18). This includes automatic meter reading, demand control switches, earthquake sensors, and a variety of early warning sensors, not shown. The integrated PLUM sensor's Master Controller, and associated UltraSatNet Remote Terminals use dynamic timing windows to an accuracy of 200 nano-seconds, for hand shaking between the PLUM sensors and pole-top mounted “Master Controller” for hacker proof communications. The UltraSatNet USAT Remote distributes the GPS timing signals to co-located Master Controllers which transfer the time synchronization pulses to the respective PLUMs.

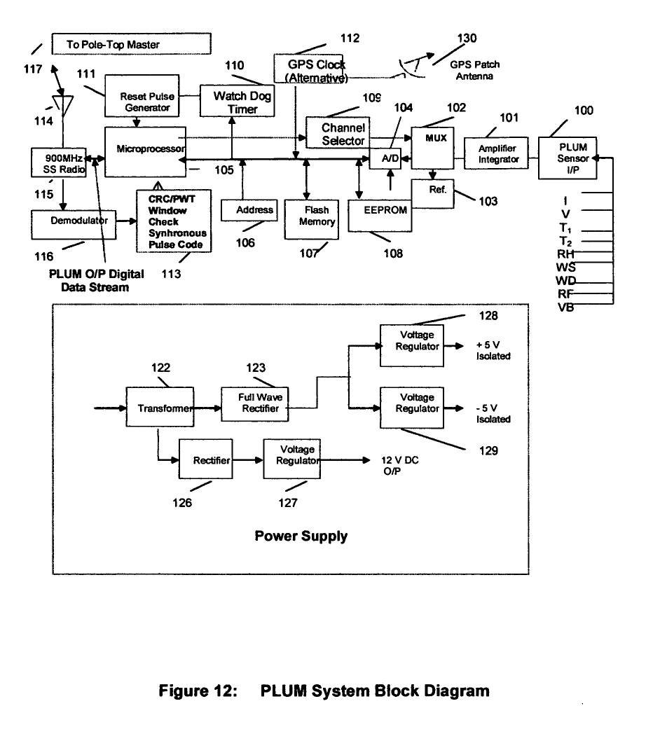

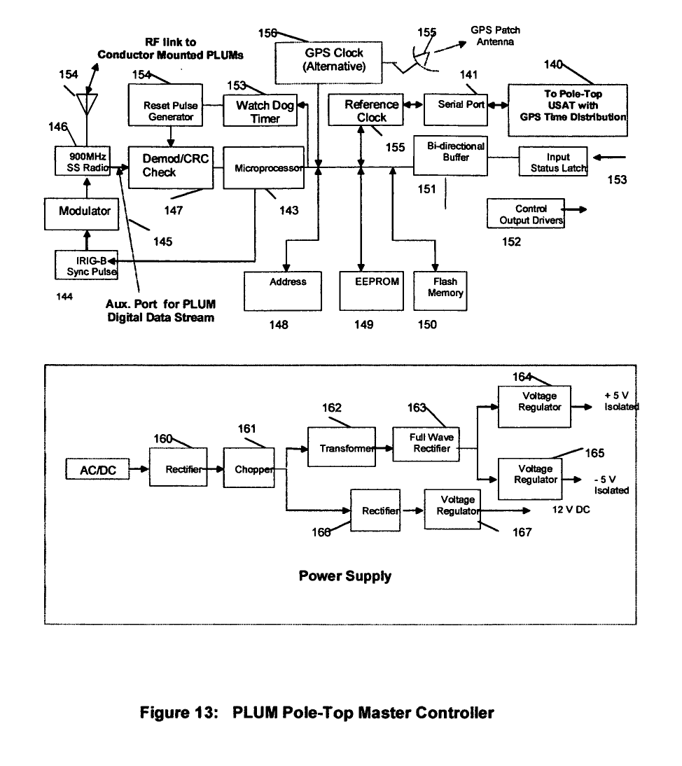

In normal operation the PLUM continuously monitors all the line parameters and reports data when polled by a Master Controller through the two-way RF Communications link 117 FIG. 12. A Master Controller (FIG. 13) can communicate with multiple PLUMs using Direct Sequence, Code Division Spread Spectrum Multiple Access Transceiver link 154 (FIG. 13). The Master Controller is co-located in a weather proof NEMA enclosure and is pole-mounted with an RS232 interface to the USAT satellite Wide Area Network communications to the Power System Control SCADA Master. The PLUM can report just the requested data set called for by the Master Controller. Alternatively, in the case of a fault identification/detection, or other event driven functions the PLUM would report the event immediately to a Master Controller without waiting to be polled or requested.

The PLUM uses a variety of sensors in the basic module using a metallized plastic or aluminum housing with a mechanical fish-tail mechanism to snap the unit around high voltage conductors for different voltages from distribution circuit voltages e.g. 4.8 kV up to transmission voltages including 500 kV. The conductor current is measured to a 0.1% accuracy using a precision Rogowski Coil Current Transducer coupled to state-of-the-art digital processing integration circuitry over the current range desired. In addition the magnitude and phase measurements by the PLUM are synchronized with respect to voltage at its location and other points along the power grid using the UltraSatNet system USAT Remote to provide GPS synchronization.

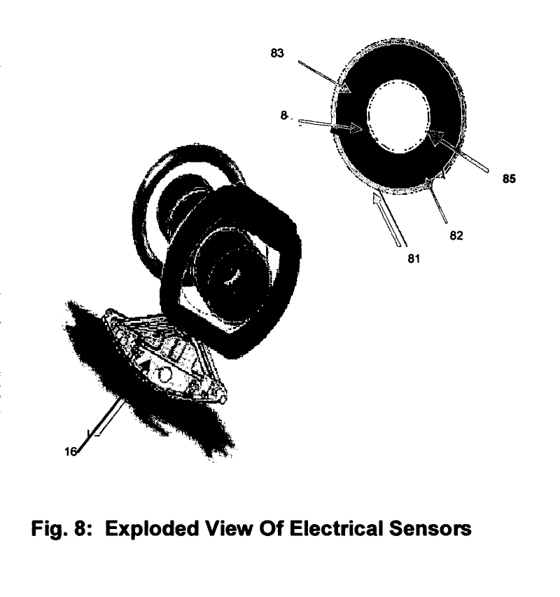

FIG. 2 shows a 3D view of the PLUM sensor open at 20, hot-stick mountable on a live high voltage power conductor with the conductor temperature sensor 26 and air temperature sensor 27, and the hub insert 28 visible. The hub capacitor insulating end-caps to protect the voltage sensing capacitor 28 is shown at 29 (FIG. 2). The open/close drive mechanism 25 (FIG. 2) is in an aluminum casting 16 (FIG.8), enclosed in a high strength plastic housing 35 (FIG. 4), is used to snap the PLUM around the high voltage conductor 33 (FIG. 4).

FIG. 3 provides a PLUM longitudinal view and the physical locations of the air core current sensor coil 21, rechargeable battery back-up 22, and split laminated core power supply core 23. The battery back-up assembly can also be mounted in a separate sensor compartment providing the connections to the interior are EMI shielded. The transceiver patch antenna is shown at 24.

The conductor voltage to ground is determined in the present invention by measuring the E-field charging current through unique parallel/series, or series/parallel capacitors between the high voltage conductor and the cylindrical conductor housing. Unlike the prior referenced configuration also disclosed by the current inventor, the present invention uses multiple hub capacitors separated by insulating rings, and protected from the effects of precipitation by shrouding the capacitors with insulating end rings 29 (FIG. 2) and designed to be large enough to eliminate stray capacitance and adjacent energized conductor effects on measured voltage accuracy even under inclement weather conditions. This overcomes a problem that prevents the previously disclosed hot-stick mountable sensors from being accepted for accurate power flow metering and energy measurement applications where a voltage accuracy of about 0.2% is required. The synchronizing, hacker-free security, and all-weather reliability greatly improves the range of applications of the current invention. Final calibration is done at the time of installation of the PLUM during installation, next to the conductor insulator string. This is made practical through the two-way communications link and inherent 200 nanosecond or better reference timing accuracy of the UltraSatNet wide area network interface or GPS derived clock signal. The Voltage accuracy is assured by measurement through multiple weather shielded stacked coaxial tubular capacitors, separated by insulating plastic split rings between the power conductor and PLUM metallic housing.

A one-wire bus for temperature sensing allows use of multiple temperature sensors to meet requirements. The conductor temperature can be measured by a non-contact infra-red sensor or an IC chip based contact temperature sensor. The air temperature is measured using a non-contact RTD type probe.

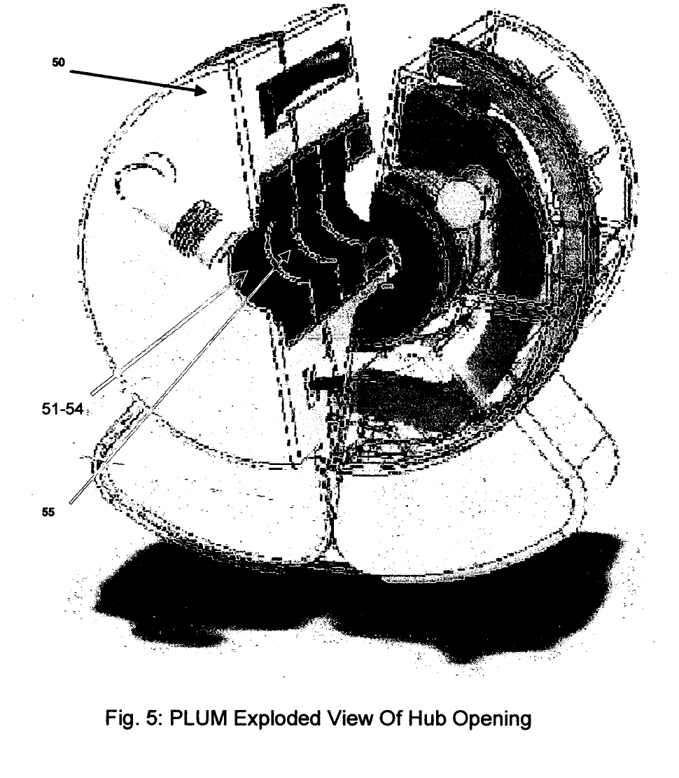

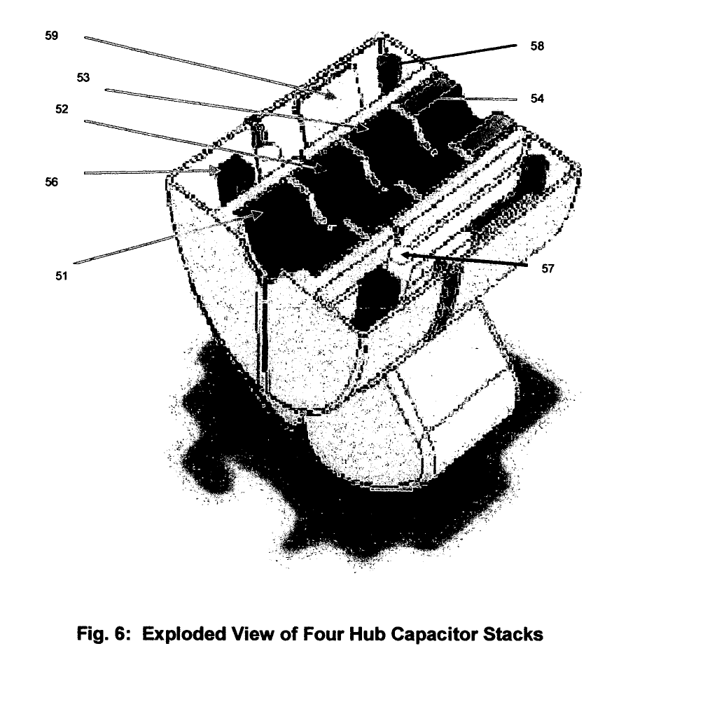

FIG. 4 shows a cross sectional view of the PLUM exposing the multiple hub core split metallic rings 30 & 31, split circumferential dielectric coating junction 32 between the split Hub ring assemblies 30 & 31. These rings are stacked longitudinally along the conductor to form four capacitors that can be connected in a parallel, series, or series-parallel configuration as displayed in 3D exploded views of FIGS. 5 and 6.

The innermost metallic ring 30 (FIG. 4) of the split cylindrical hub insert opening 13 (FIG. 1) is separated from an outer metallic ring 31 by a dielectric split cylinder 32 that creates the sensing capacitor between the inner and outer metallic split cylinders. There are 4 such cylindrical tubular capacitors 51-54 (FIG. 5) that can be connected inside the cast aluminum housing in any combination series/parallel arrangement with each being connected to the conductor using a braided ribbon metallic connector 34 (FIG. 4). This serves to ground the RF signal while allowing the capacitor rings to generate an AC charging current that is proportional to the E-field generated by the conductor voltage.

High temperature split rubber ring 34 (FIG. 4) grips the power conductor with pass through braided electrical leads penetrating the rubber at diametrically opposite points making low resistance contact with the high voltage conductor 33. The rubber and braided conductor leads grip the high voltage conductor over a large surface area avoiding high mechanical stress points on the conductor unlike the previous inventions. FIG. 4 shows a cross-sectional view of the hot-stick mounting drive mechanism in an aluminum casting 16 (FIG. 8), enclosed in an insulating casing 35 to minimize adjacent conductor clearance encroachment. A cable of fixed length to accommodate the largest required opening is allowed to slide around the two upper pivots 38 passing through the rocker arms 36 as the hot stick tool 37 (FIG. 4) is inserted at 12 to move the drive mechanism cylinder 40, and the upper rocker arm pivots 38 apart. Alternatively, slotted rocker arms 36 are used to allow the upper pivots to move freely within the slots as the sensor housing is opened or closed around the high voltage conductor eliminating the need for a cable around the upper pivots 38. The entire assembly is made diametrically small as possible within the constraints of accurate voltage measurement and minimum conductor clearance encroachment, while protecting the sensor electronics and capacitive junction from corona conditions. To reduce encroachment of clearances between conductors the drive mechanism which is below the cylindrical aluminum housing, is encapsulated in an insulating material to avoid an increased reduction in clearance distances between conductors in a vertical plane where they exist in certain power grid locations. Thus, the drive mechanism at 35 uses either two slotted arms 36 to slide across the top pivots or a cable arrangement over the top pivots to help actuate opening or closing the PLUM around the energized High Voltage conductor when the hot-stick tool is inserted at 12. Unlike the inventor's prior invention the present configuration allows maximum surface area contact with the conductor, and allows a flexible increase in capacitance to swamp effects of stray capacitances. The hot-stick tool inserted in the drive mechanism cylinder 40 is shown not to scale at 37 (FIG.4).

FIG. 5 shows an exploded view of the voltage sensor with multiple capacitors 50, stacked (51-54) in four assemblies separated by insulator rings 55 to allow parallel, series, or series-parallel connections for desired voltage measurement sensitivity for voltage ranges from distribution 4.8 kV to 500 kV transmission. The unique cylindrical split hub capacitor stacks 51-54 (FIG. 6) that would work accurately in an outdoor high voltage conductor environment and integral to the PLUM sensor module housing itself has never been successfully manufactured or disclosed prior to the current invention. Much less in a manner that would be self calibrating and providing metering grade accuracy for all the parameters measured in the context of wide area high voltage power system control for maximum stability and power transfer.

FIG. 6 shows an exploded horizontal 3D cross-sectional view of the 4-segment capacitor stack 51, 52, 53, and 54 arrangements for parallel/, series or series-parallel connection separated by insulating rings 55, which could also be connected as a single cylindrical capacitor parallel arrangement without the insulated separator rings. Insulated end rings 29 (FIG. 2) are used to protect the 4 hub capacitor stacks 51-54 FIG. 6 from precipitation. Also shown exposed are the laminated power supply core 56, rechargeable battery pack 57, electronic cards 59 and Rogowski current coil 58 specially designed for a single or two-layer maximum accuracy configuration with counter current flow. Unlike previously disclosed inventions the PLUM sensor module cylindrical housing configuration of the current invention allows the individual current, power supply core and coil, rechargeable battery pack, and open/close drive mechanism to be placed in separate planes, eliminates a concentrated mounting stress point on the conductor surface and also meets the compact single hot stick mounting feature. The multiple cylindrical hub capacitors for parallel connections provide maximum capacitance and uniform conductor grip surface area to avoid high mechanical stress points while maximizing sensor voltage accuracy. In addition the PLUM configuration shields the internal electronics and RF circuitry from corona and avoids the necessity and weight of high voltage corona rings.

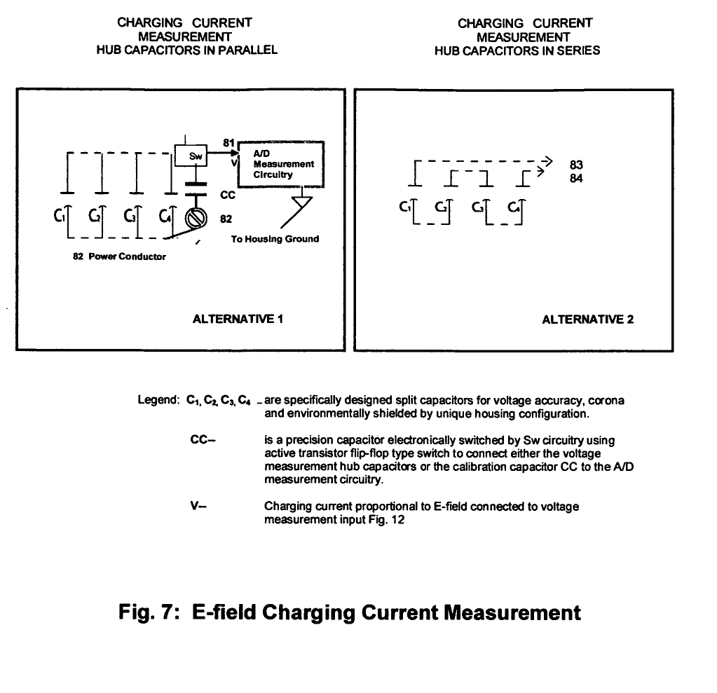

FIG. 7 shows alternative connections for the hub capacitor ring assemblies in a parallel 81-82 or series 83-84 arrangement, or a not shown series-parallel arrangement. The dynamic Calibration Capacitor CC, can be switched into the measurement circuitry in place of the four parallel Hub Capacitors C₁, C₂, C₃, and C₄ by well known electronic switching circuitry shown generally by a “Switch” box in FIG. 7. The precision capacitor CC is selected to dynamically calibrate any change in hub capacitance due to stray capacitance or other effects, and unlike the hub capacitors, it is selected to provide maximum sensitivity to environmental variation which can be used to modify the calibration factor at the time of installation.

FIG. 8 shows an exploded view of a single hub insert assembly consisting of an outer metal adapter ring 81, dielectric separator 82, inner capacitor metallic ring 83, conductive high temperature rubber 84 with pass through braided conductor contact points 85 connected through the hub capacitor to internal electric field charge current measurement circuitry, wherein the charging current is directly proportional to conductor voltage. The inner hub insert assembly metallic ring 83 is adjustable to accommodate the range of high voltage power conductor diameters. Also shown in the figure is the drive mechanism assembly 16.

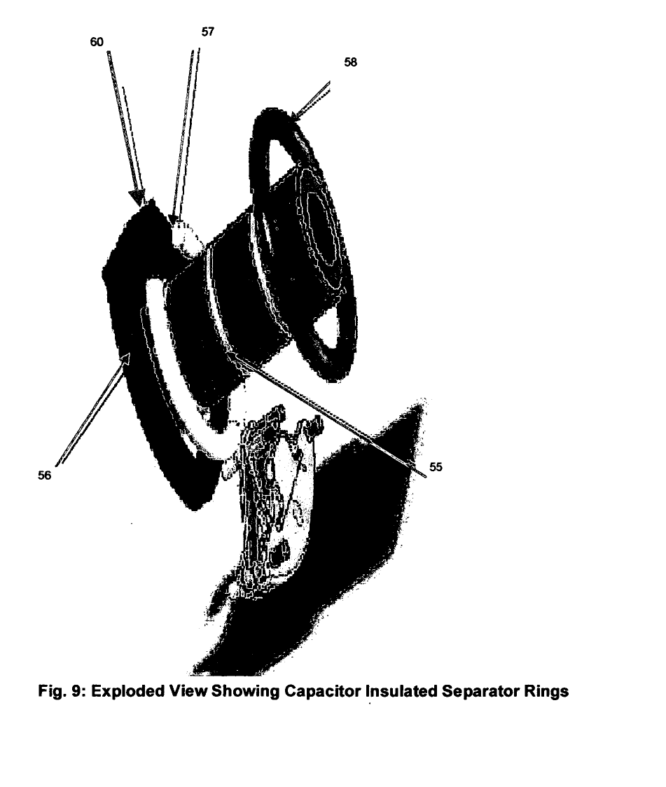

FIG. 9 shows a more longitudinal exploded 3D view along the conductor axis with a clearer view of the capacitor separator rings 55, used if the series parallel option is desired in preference to a purely parallel connection which allows elimination of the hub insert capacitor assembly separators. Also shown are complete 3D views of the laminated power supply core 56 and power supply coil, rechargeable battery pack 57, Rogowski coil 58 and capacitor ring assemblies separated by insulator rings 55. Also shown is the power supply coil with encapsulated surge protection 60, disclosed in referenced prior inventions. Unlike previously disclosed high voltage power sensors the present invention locates the core and coil, battery pack and Rogowski coil in different planes along the cylindrical axis of the high voltage conductor, provides far greater voltage sensitivity through an improved protected E-field voltage sensor and allows air circulation through the hub core for improved performance of all sensor measurements and by moving the temperature sensors to the outside to avoid influencing the temperature measurement by heat generated within the sensor module, preferably using a non-contact IR, IC chip, or fiber-optic conductor temperature sensor.

3.0 PLUM Electronics Architecture

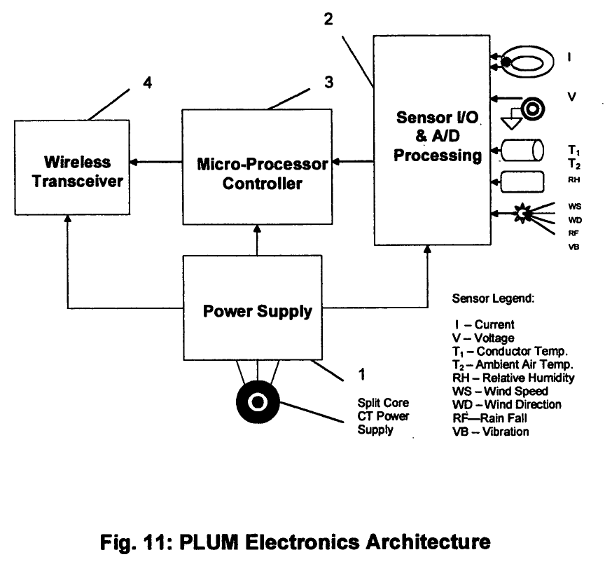

FIG. 11 shows the PLUM wireless sensor module is made up of four electronic subsystems,:
Power Supply, 1.
Sensor I/O & A/D Processing, 2.
Micro-Processor/Controller, 3
Wireless Transceiver, 4

The disclosed fully integrated PLUM sensor includes a Microprocessor Controller 3 (FIG. 11), high speed sampling circuitry, sensor I/O and A/D Processing 2 (FIG. 11), power supply 1 (FIG. 11), Wireless Transceiver two-way RF communications 4 (FIG. 11), GPS synchronizing 130.

3.1 Power Supply

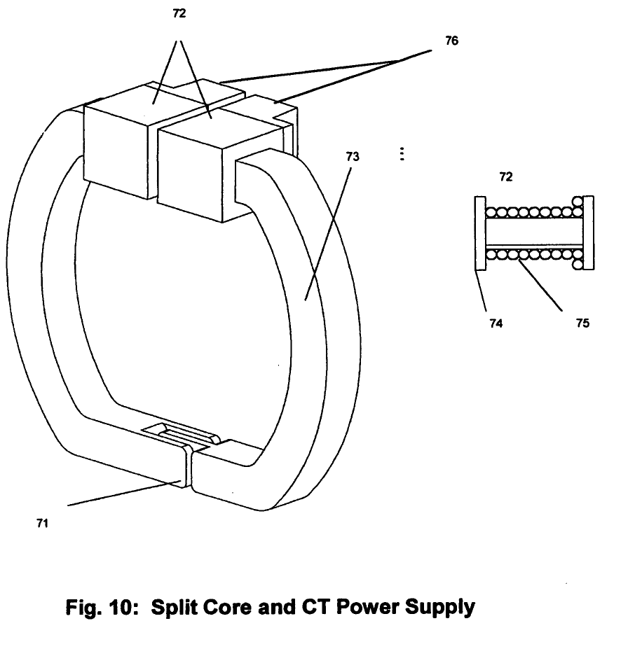

A laminated iron core split at the top and at the bottom, FIG. 10, allows hot-stick mounting around a high voltage conductor. A guide is used to keep the left and right half laminated core segments aligned as the drive mechanism opens and closes the split cylindrical section of the housing around the high voltage conductor.

Further shown in FIG. 10 is the split core 73 and coils for the power supply with encapsulated surge protection 76. Several interface options are possible for the bottom core junction, including a coated flat interface to avoid laminated steel core corrosion.

Two coils 72 wound around a plastic bobbin 74 and power supply CT coil cross-section 75 surround each of the top mating laminated split core segments 73. The single primary turn created by the high voltage conductor and 120 turn secondary winding serve to electromagnetically transform the high current primary to a low voltage, low current secondary.

The output of the secondary multi-turn winding is protected by GE-MOV type solid oxide surge arrester and a Littlefuse surface mount switching surge and transient suppressor. The AC voltage is converted to a DC voltage using a diode bridge, filter and DC voltage regulator to produce the required DC voltages for the various electronic boards within the PLUM module. Several National Semi-conductor regulators such as LM 2940 can be used for the regulated DC power supply.

3.2 Sensor I/O A/D Processing

The basic PLUM sensor consists of current sensing circuitry 100,101, 102, 103, 104, voltage sensing circuitry comprising electric-field capacitor voltage sensor 100, 101, 102, 103, and 104, zero crossing detector using voltage and current measurement circuitry and Microprocessor Controller 105, and synch pulse detector 113 through transceiver circuitry 115. The air temperature sensor and conductor temperature sensor are provided only if the application calls for dynamic rating of the power conductor. Analog to Digital conversion and integration circuitry are provided on this board. GPS synchronization can alternatively be provided using GPS patch antenna 130, GPS clock circuitry 112 providing the synchronizing clock signal. Watch dog timer 110 prevents freeze-up conditions through reset pulse generator 111. PLUM serial data is tramsmitted through the 900 MHz radio patch antenna 114 to the pole-top Master Controller transceiver antenna 117.

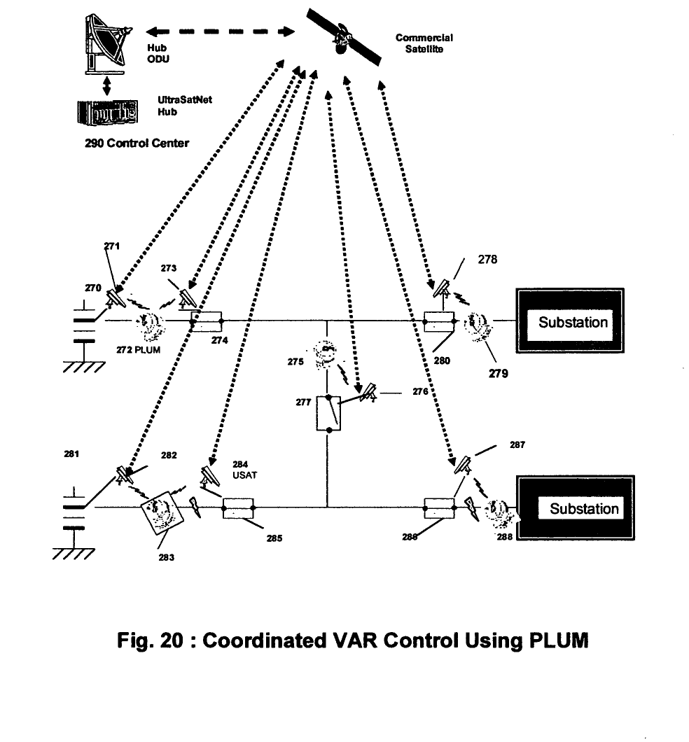

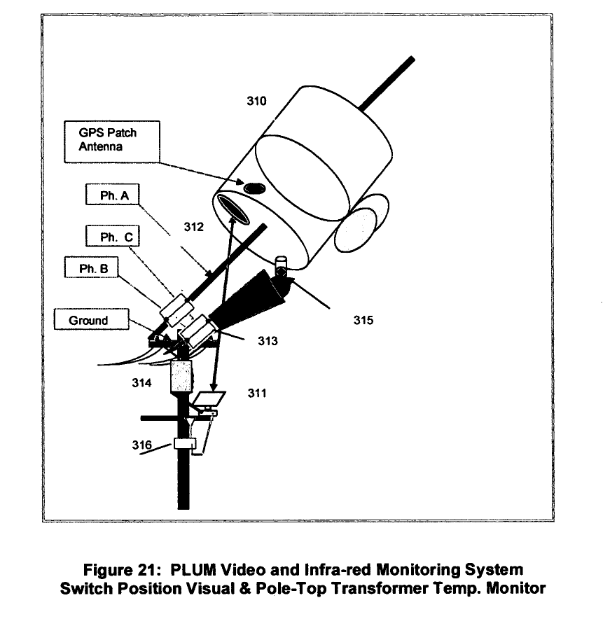

A separate board can be used for the video cam triggered snap shots (FIG. 21) to monitor physical open/close positions of a co-located switch (FIG. 20) operated through a remote control UltraSatNet SCADA channel 311. Other analog sensor signals are also processed by the same A/D circuitry.

3.2.1 Sensor Selection

The sensing techniques used need to provide accurate measurements under normal, short-term fault and transient fault conditions. This implies that the sensor cores should not saturate and the current and voltage sensors need to provide ±0.1% and ±0.2% or better accuracy respectively over the range of interest. The synchronization pulses should limit measurement time skew between PLUMs to less than 200 nanoseconds representing phase measurement accuracy better than 0.01 degrees.

The primary sensors are for current and voltage measurement for distribution automation. For transmission voltages conductor temperature and ambient temperature sensors are needed for dynamic line ratings.

3.2.1.1 Rogowski Current Transducer Coil

An air core current transducer suffers from hysteresis, saturation during high current conditions and inaccuracies over a wide current range. A Rogowski coil configuration is chosen for high accuracy, good linearity and freedom from saturation problems using a tubular air-core and surge protected with a metal oxide varistor. The Rogowski Current Transducer (RCT) is designed as follows:
For a wide current range with a single sensor
To avoid saturation using a tubular air core and to avoid damage by fault currents
To eliminate harmonics created by magnetic cores and eddy current heating
Linearity over the desired measurement range
High bandwidth needed for transient current and harmonic current measurements
Mechanical flexibility for integration with the PLUM housing and the open/close drive mechanism for hot-stick mounting
To include temperature compensation
Low impedance to avoid loading the measurement circuitry over the desired range

The Rogowski coil is wound as a toroidal winding and the return path is brought out through the middle along with surge protection to allow all connections at one end. The Rogowski coil is wound on a flexible uniform circular non-magnetic core, split in the middle. The tubular core is selected with material that prevents deformation of a true circular configuration, concentric with the power conductor, split only at one location with the gap minimized and in the same plane as the split core. For continuous accuracy the coil must retain its circular form and remain concentric over the operating temperature range of the high voltage power conductor. The two ends of the winding are brought together at one end of the circular split coil forming a loop around the conductor carrying the current to be measured. The electromagnetic flux produced by the alternating conductor current creates flux linkages per ampere of conductor current. The accuracy of the Rogowski Current Transducer (RCT) is further improved by an inner counter wound tube allowing appropriate series polarity connection to the measurement circuitry at one end. This is a distinguishing feature from the earlier invention. The inner and outer Rogowski coils are wound on plastic tubing that is formed into a split flex circular coil that can be trapped at each end at the split casting interface with the gap made as small as possible.

In an alternating current circuit the electromagnetic field is time variant and circles the conductor in a uniform manner across the RCT cross section. The magnitude of the field and hence the flux it produces is directly proportional to the conductor current and its rate of change. The time variant field induces an Electro Motive Force (EMF) or voltage in the RCT surrounding the conductor. If the current is a DC source the rate of change is zero and therefore there is no EMF or voltage induced in the coil. However, there is a rate of change of current that creates a spike when the DC current is switched on or switched off. The magnitude of the EMF, E is proportional to flux linkages (Number of turns N & cross-sectional area A of coil) and rate of change of current and can thus be expressed as:

E=4π(NA)10exp-7(di/dt)

The Rogowski coil output is larger for faster current transients. Its output signal needs to be integrated to determine the current from the measured rate of change over the period of the waveform. Analog devices provides a sensor interface with a built-in digital integrator, for example, ADE7753 would accept input from the RCT to provide an accurate current measurement option avoiding the conventional Current Transformer (CT) saturation problems faced in relaying and metering applications.

The Analog Devices ADE7753 Energy IC provides a direct built in di/dt sensor interface for the Rogowski coil. Its digital integrator provides excellent long term stability and precise phase matching between the current and voltage sensors. This feature is critical for phasor measurements and accurate real and reactive power measurements. The ADE7753 also stores current, voltage and power waveform data in sample registers. Waveform data is sent to the micro-controller via the serial port interface bus for accurate measurement of current, voltage, frequency, and phase, and power factor, real and reactive power. The ADE zero crossing detector output is used by the micro-controller to gate the sampling accumulator. A precision reference voltage such as an Analog Devices AD 780 can be used to check Rogowski coil calibration over time.

3.2.1.2 Voltage Sensor

Accurate conductor voltage measurements, better than 0.2% at conductor potential, is determined in the current invention by measuring the E-field charging current through unique, split hub capacitors made up of rings stacked to allow series parallel connections between the PLUM housing and the conductor. The housing configuration for the PLUM allows the capacitance to be maximized through parallel connection of multiple capacitors for manufacturing convenience or by separating two concentric hub cylinders with the highest available dielectric (ceramic material) constant (or series/parallel) to measure the charging current between the conductor and housing. Unlike, prior inventions the capacitors are free from corona conditions and shielded from any environmental precipitation to maintain accuracy over a wide range of ambient conditions. The charging current is directly proportional to the line voltage and is calibrated at the time of installation. Unlike prior inventions, a highly accurate precision reference capacitor is switched in and out of the measurement circuitry at periodic intervals downloaded from the Master Controller. The PLUM is dynamically calibrated “on-line” through a measurement of the change in a precisely known and pre-calibrated internal capacitance due to second order stray capacitances. This change in capacitance is measured by the same circuitry measuring the charging current through the hub capacitance. This is conveniently done by measuring the change in current through known precision capacitive impedance between conductor and ground. Unlike a prior invention of the current inventor the accuracy is improved by eliminating the point contact configuration of the PLUM hub and instead using a large cylindrical surface area contact with the high voltage conductor and using a high dielectric constant material between the hub concentric cylinders, with a method to dynamically measure and eliminate stray capacitance effects in addition to selecting the appropriate calibration factor by determining whether adjacent conductors are energized or not. All power flow quantities are sensed, calibrated and digitized on the high voltage conductor and synchronized by the Master Controller GPS timing or if not available at the particular location by an autonomous GPS timing circuitry within the sensor module. These GPS timing devices with patch antennas are commercially available.

3.3 Micro-Processor Controller

The Micro-Processor Controller board 3 (FIG. 11) represents the brain of the PLUM and receives all the measured sensor data via a micro-processor bus interface 105. The register values are read and written to via this bus. Air temperature and conductor temperature inputs are routed directly to the microcontroller. The data from external sensors is obtained by the microcontroller polling each sensor channel. The microcontroller sends information to the PLUM Master Controller/USAT interface via a two-way wireless link on a polled or event driven basis.

A high speed DSP micro-processor 105 (FIG. 12) contains the application code to generate the desired output current, voltage, precise phase angle, and frequency. The measured RMS current, voltage, frequency and phase are used to compute MVA, power factor, real and reactive power. The necessary Fast Fourier Transform waveform processing to generate the harmonics for fault identification through a comparison of “present” abnormal waveforms or harmonics of current and voltage with continuously stored pre-selected average multiple records are also conducted by the micro-processor/DSP.

The typical AC voltage and current waveform contains harmonics. To determine the true RMS value of the voltage and current each waveform is sampled and integrated over one or more cycles. The number of samples taken depends on the accuracy required, harmonics, and the transients to be measured. Analog Device ADE 7753 chip uses two delta sigma A to D's that can provide over 400 samples of the voltage and current waveforms at sampling intervals down to 36 micro-seconds. The RMS value is then easily calculated by the micro-processor from the sample magnitudes and the number of samples per measurement. Analog Device ADE 7759 with an on-chip digital integrator allows a direct interface to a Rogowski coil with a di/dt output voltage and has a good dynamic range. The device calculates the apparent, real and reactive power from the measured voltage, current and phase angle. The instantaneous power is calculated from a direct product of the instantaneous voltage and current samples taken simultaneously. The reactive power is the value of the voltage and current product when one of the vectors is phase shifted by 90 degrees from the other. The apparent power is the vector sum of the real and reactive power or the product of the RMS voltage and current.

3.4 Wireless Transceiver

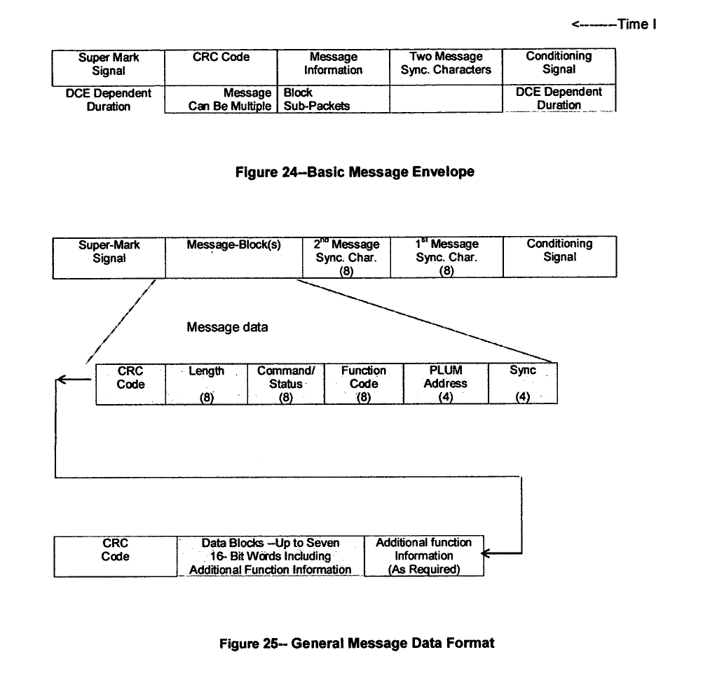

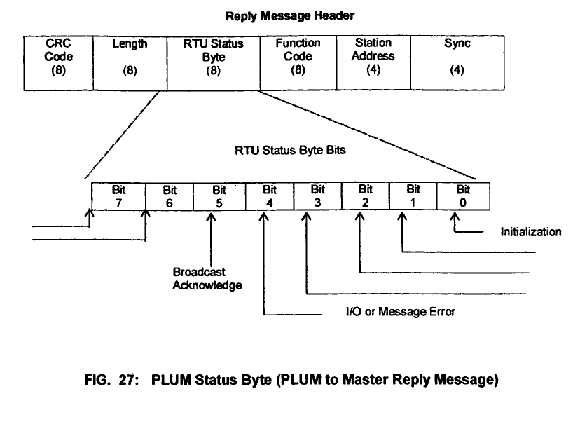

The Micro-Processor Controller card 105 (FIG. 12) communicates with the external Master Controller using a Wireless Transceiver Card 4 operating in the 900 MHz, 2.4 GHz or higher frequency spectrum. The PLUM communicates with the Master Controller in a full duplex mode using a 900 MHz RF link 117 (FIG. 12) to allow synchronization with an external USAT/GPS clock signal which is sent at preferred intervals ranging from one pulse/second to one pulse/30 seconds as required by the application or charge status of the PLUM rechargeable battery 57 (FIG. 6). The wireless link preferably uses direct sequence spread spectrum (DSSS) code division multiple access (CDMA) technique. The RF Transceiver 115, (FIG. 12) interfaces with the micro-processor 105 (FIG. 12) and is used for transmitting RMS voltage, current, frequency, phase angle, apparent power, real and reactive power, power factor, conductor temperature, air temperature, and alarms for low voltage, fault current, Auto Recloser (AR) operations, PLUM diagnostic alarms and status parameters. Each PLUM has a unique 4 to 6 digit address for communication with the Master Controller using a full duplex 902 to 928 MHz, 2.4 GHz or higher frequency RF transceiver link 117. The PLUM synchronizing pulses are received from the Master Controller via the full duplex 900 MHz RF Transceiver Link 117 or alternatively a fiber optic link. The messaging formats are described in the following paragraphs and depicted in FIGS. 24-28.

Scan Messages

Request Message Format Descriptions

Scan messages are used by the Master Controller to retrieve parameter data from the PLUM(s). For example, a normal scan function can be used to scan all parameters from PLUM address xxxx, or a broadcast (B) message used for a simultaneous response of data from all PLUMs reporting to a specific Master Controller using GPS synchronized well known direct sequence spread spectrum, code division multiple access RF communications between the PLUMs and the Master Controller.

All scan message sequences consist of a scan request message and a scan reply message.

The Master Controller begins the scan operation message sequence by transmitting a scan request message for a specific PLUM, or all PLUMs reporting to it. The UltraSatNet hub transmits the scan request message to the USAT connected to the designated PLUM to perform the scan operation. In response to the scan request message, the PLUM transmits the scan reply message to the USAT for transmission to the SCADA Master via the UltraSatNet Hub interface.

Reply Message Format Descriptions

The scan reply message consists of a reply header that may or may not be followed by one or more reply data blocks. The reply header is a statement of the scan request message. Depending on the number of input points and the type of scan requested, the remainder of the scan reply messages may contain one or more reply data blocks.

The specific types of scan data contained in the reply data block data words depend on the type of scan performed. A scan data word can contain status, analog, or pulse-accumulator data.

Each message has a defined format enclosed within a signaling envelope. Within the envelope, the messages envelope packet contains message blocks, including a standard format message header as a minimum and additional data blocks as required.

Memory Read/Write Messages

Memory read/write messages are used by the Master Controller to transfer special data to the PLUM memory and retrieve data from the PLUM memory,

The message sequence consists of a memory read/write request from the Master Controller followed by a memory read/write reply from the PLUM.

Message Envelope

The message envelope packet consists of conditioning signals, if used, at the start and end of every message needed to satisfy signaling requirements of the data communications, FIG. 24.

As a standard convention all message formats are shown with the first data bit transmitted to the right.

The conditioning signal is a mark (digital 1) that precedes all messages to settle noise on the communications channel and to allow the receiver to activate before a message is transmitted. The signal duration is typically configurable within the PLUM. This signal occurs only once for a message.

The message synchronizing characters are two 8-bit characters that indicate the start of a message. Each sync character is equal to 16 (hexadecimal). The sync characters precede the first message block only, even if a complete message contains multiple message blocks.

Message Block Format

Each message block consists of two components: 1) The message information for the block and, 2) The CRC code generated from the message information. Each of these components is described below:

The CRC code is an 8-bit code that is used by the receiving device to detect channel-induced transmission errors. After each start bit, the transmitting device firmware uses the message information to calculate a Bose-Chaudhuri-Hocquenghem (BCH) code. The generating polynomial for the 8-bit CRC code is as follows:

X⁸+X⁷+X⁴+X³+X+1.

The CRC code is computed by starting with an initial value of all one bits. The result is implemented before transmission. This code is unique to the specific pattern of data in each message; therefore, when the code is regenerated at the receiving device, using the received message data, the two codes should match. This ensures the detection of channel-induced transmission errors. In some messages, such as scan replies, there maybe several message blocks; therefore, some messages contain several CRC codes (one at the end of each message block). The BCH code is a form of cyclic redundancy checking therefore, the abbreviation CRC is used.

The message information may consist of various items, depending on the type of message block in which it is contained. These items might include the function to be performed at the PLUM, the address of the PLUM, any additional information that is required by the specified function, or a volume of data for transfer.

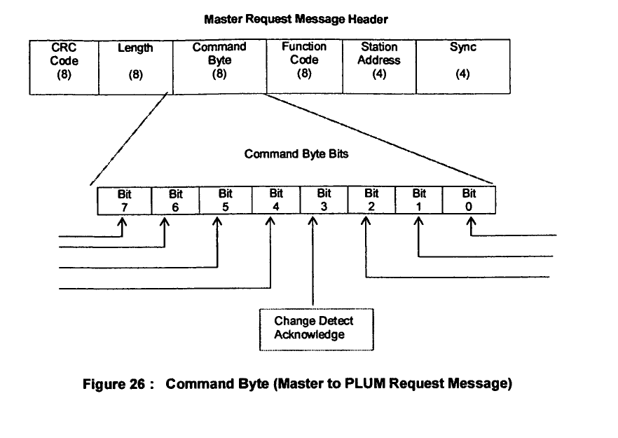

As shown in FIG. 25, the message information and CRC code combine to form a message block. There are two main categories of message blocks: 1) The header block and 2) The data block. A complete message is comprised of a standard format header block as a minimum and additional data blocks as necessary. The next two paragraphs describe the formats of the message header and data blocks in more detail.

Message Header Format

In addition to the CRC code, the message header format consists of five fields: sync, PLUM address, function code, command/status, and length.

The first 4 bits in the message header are sync bits that are present only to maintain compatibility with the header format of the asynchronous version of the protocol. They are always set to 4 (hexadecimal). The PLUM address is the next 4 bits following the sync bits. This code indicates the specific remote terminal to which the message is being directed or from which the message is being transmitted. The next 8 bits are the function code. The next 8 bits following the function code are the command/status bits. In a request message, these bits augment the function code by directing PLUM operation and are termed the command bits. In a reply message, these bits report on various PLUM activities and are termed the status bits. In preferred embodiment, the fifth bit in these eight bits is a Broadcast Acknowledge bit. When set in the status portion of the reply message, this bit indicates that the last request message was to the universal broadcast address (B). Because there is no reply message from the PLUM in response to the broadcast address messages (such as, accumulator freeze), this bit is used by the master controller as a delayed confirmation that the PLUM received the broadcast address messages. Finally, a length byte (8 bits) follows the command/status bits. The decimal equivalent of this length byte specifies the number of 16-bit data block words, including additional function information but not including the CRC code, that follow in the data block(s). In a case where there are no data block(s) that follow the request or reply header message, this length byte is set to zero.

Data Block Format

The data block(s) follow the request or reply header block. Each data block consists of: up to seven 16-bit words (112 bits) and an 8-bit CRC. The last data block, and only the last data block, in a message will contain fewer words if there is insufficient data to fill a complete block.

Additional function information may be contained in the data block depending on the function specified. The additional function information is considered to be part of the complete data block; therefore, it reduces the amount of actual data that can be contained in the data block by the amount required for the additional function information. This additional information may be the start and stop sequence numbers of a scan function, setpoint parameters, locations and data length for memory read/write functions, or a sequence number that specifies a point to be controlled.

Data words that represent PLUM point status, accumulator information, analog values, or memory data that is being transferred to or from the PLUM are returned in the data block(s).

Message Format Descriptions

The message formats show the data transmission from right to left; the first bit transmitted is on the right and the last bit transmitted is on the left.

Scan 1 and Repeat Scan 1 Messages

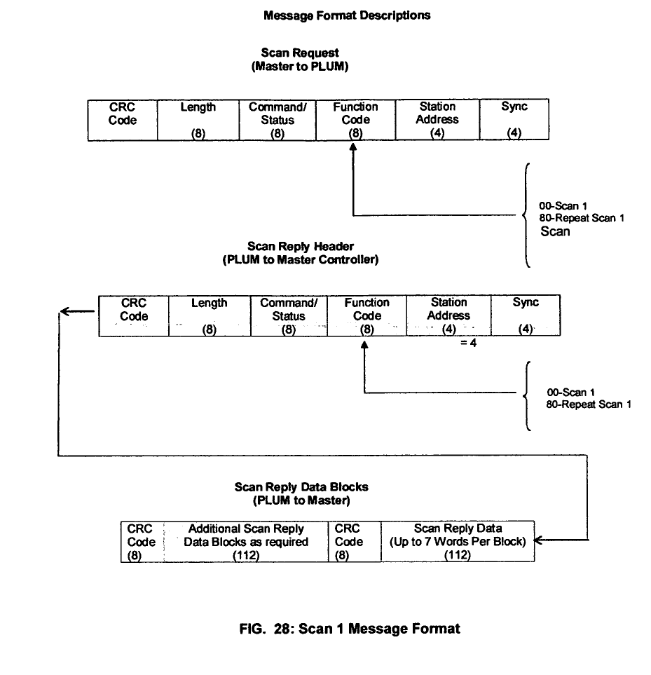

FIG. 28 shows the scan 1 and repeat scan 1 message dialogs. The request message portion directs the PLUM to return all simple-status data, all 1-bit and 2-bit change-detect status data, and all analog data.

FIG. 28 further illustrates the preferred format of a scan 1 message. The dialog of this format consists of a request message, a reply header, and one or more scan reply data blocks.

The request message consists of the header block with the function code equal to 00 (hexadecimal). The length byte is equal to zero (00 hexadecimal) since no additional request data follows.

The scan reply is identical to the scan request except the command/status bits following the function code are the status bits that now contain a report of remote terminal status as previously described in the Message Header Format paragraph. In addition, the length byte in the scan reply defines the quantity of 16-bit words in the scan reply data block(s) that follow the scan reply header. This number is variable according to the PLUM configuration.

The reply message data is ordered by sequence numbers. Sequence numbers correspond to specific physical input points and define the grouping of their associated data within the message.

The repeat scan 1 request message allows the master controller to recover from a communication error in the previous scan 1 response message from the PLUM, This function causes the PLUM to repeat the previous scan 1 reply data block(s) exactly as they were transmitted.

The dialog of the repeat scan 1 messages is identical to the scan 1 dialog and format, except the function code is equal to 80 (hexadecimal) as shown in FIG. 28.

The repeat scan 1 function causes the remote terminal to repeat the previous scan 1 reply data block(s) exactly as they were transmitted prior to the error, To ensure error recovery, this function must be requested immediately after the previous scan 1 communication dialog where the error occurred; however, intervening control operations can be performed without affecting the error recovery capability.

If the remote terminal responded to any other scan request after the error occurred, the repeat scan 1 reply from the PLUM contains no data. In this case, the error is not recoverable because the remote terminal scan buffer has been overwritten. If the change-detect non-acknowledge was sent to the remote terminal, no change-detect data has been lost, even though the repeat scan 1 failed.

Other Scan messages can be similarly constructed, with different function codes and repeat scans.

The key measurements that need to be made accurately are the RMS voltage, current, phase at zero and peak sample parameter measurements, all with respect to a clock synchronization preferably below 200 nanoseconds for demanding IRIG-B relay applications.

FIG. 12 is a detailed block diagram which shows a preferred embodiment for the integrated PLUM sensor electronics. The PLUM sensor analog input signals, generally shown at 100, are connected to the high speed sampling, A/D conversion and MUX circuitry 101, 102,103, & 104 under the direction of the micro-processor controller circuitry 105, 106,107 & 108, and sensor channel selector 109.

The current and voltage waveforms are generated by high speed sampling of the 60 Hz signals to generate the highest waveform frequency harmonic component to be measured. The over-sampling required is essentially governed by the highest harmonic that needs to be captured. This processing is done in a micro-controller or DSP that can handle the maximum sampling rate dictated by the highest harmonics to be measured and the rise time of transient measurements to be made, including lightning transients. Triggers set allow, for example, the short duration waveform of a sharp rise time lightning transient to be captured for digital Fast Fourier Transform analysis and transmission of this event to the PLUM Master Controller with the GPS location and PLUM sensor address information to be transmitted to the operator or appropriate Central Power Dispatch server over the wide area USAT satellite network or alternative WAN. This information can then be supplied to the appropriate Engineering or Relay Group responsible for protection coordination, selection of lightning arrester ratings and in general required equipment BIL for various power system voltages/locations.

The micro-processor freeze-ups are avoided by a Watch-Dog Timer 110 and Reset Pulse Generator 111. Time synchronization is achieved through the two-way communication link RF antenna 114, Demodulator 115, CRC Check and UltraSatNet USAT IRIG-B Synchronization Pulse Code Detector 113. If not available through a GPS patch antenna and internal GPS timer circuitry. The PLUM Power Supply consists of the previously described core and transformer coil with the power conductor acting as the single turn primary. The Power Supply circuitry block diagram consists of a Transformer 122, Full Wave Rectifier 123 and voltage regulators 128, 129 generating the ±5 V DC voltages. Other DC voltages, e.g. 3.5 V DC, 12 V DC, etc. can be generated through the core and coil transformer, rectifier 126 and voltage regulator 127. Each PLUM has a unique 4 to 6 digit address and the RF transceivers use Direct Sequence Spread Spectrum (DSS) Code Division Multiple Access (CDMA) links for simultaneous communication with the Master Controller FIG. 13. The RF transmissions are made more reliable through a grounding capacitor between the transceiver antenna and the power conductor, not shown in this block diagram.

This is similar to the approach disclosed by the current inventor in the Hitless Ultra Small Antenna Terminal patents using direct sequence spread spectrum techniques coupled with Time Division Multiple Access (TDMA) windows. This is further enhanced through the GPS time synchronization of simultaneous PLUM sensor CDMA data bursts to the PLUM Master Controller.

FIG. 13 is a block diagram of the PLUM Master Controller which can be Pole-Top or Substation Control House side-wall/roof-mounted. The PLUM Master Controller uses two-way communications with the conductor mounted PLUM sensor modules on each conductor phase. The PLUM Master Controller transmits the IRIG-B Synch Pulse Generator 144 signal through Modulator 145, Transceiver and RF patch antenna 146 to the PLUM sensor modules under the control of microprocessor 143. The Address 148, EEPROM 149, and SRAM or current high speed Flash Memory Modules 150 represents a standard memory configuration for the PLUM Master Controller. The IRIG-B Reference Time Clock for the PLUM sensor synchronization is generated from the UltraSatNet satellite GPS time distribution, if the PLUM Master Controller is co-located with a pole-top mounted USAT. If not, a second option is to use the PLUM GPS patch antenna 155 and internal PLUM GPS timer circuitry 156 to generate the IRIG-B time synchronization within the PLUM sensor itself. The Master Controller contains a bi-directional Buffer 151 and the Wide Area Network USAT link is used to communicate SCADA commands via the PLUM Master Controller using Control Output Drivers 152 to Open/Close a Pole-Switch in a manner similar to a utility Remote Terminal Unit (RTU). Input Status Latch and digital data is returned to the Central or Regional SCADA Operator location along with the PLUM Sensor data using the USAT Remote Terminal. A Watch Dog timer 153 and Reset Pulse Generator 154 are used to prevent freeze up conditions. Output of a 12 V AC/DC transformer source for the Master Controller is fed to rectifier 160. Rectifier 160 and chopper 161 connected to an electronics power supply transformer 162, full wave rectifier 163 and voltage regulators 164, 165 to produce ±5 V DC. Similarly the chopper 161 output fed to a half wave rectifier 166, and voltage regulator 167 generates 12 V DC. This allows all the electronic circuitry within the PLUM Master Controller to be fed from a single input source at a pole-top or sidewall control house within a utility substation. Dual regulated DC power supplies are used with the power conductor AC current CT Power Sources 72 mounted on split silicon steel laminations 71 FIG. 10 to provide a reliable power source for a wide range of applications. The dual regulator DC power supplies are not needed if the PLUM is used for SCADA monitoring applications only.

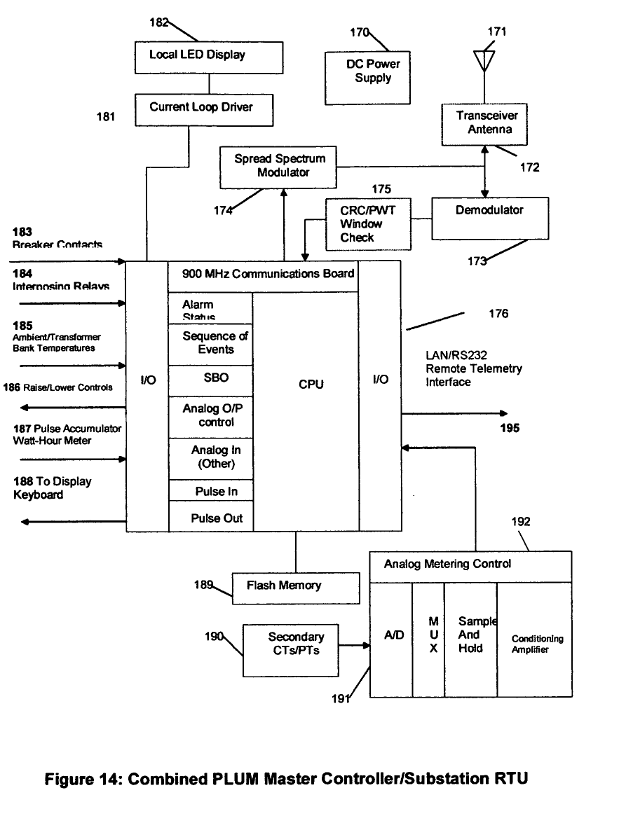

FIG. 14 shows how the PLUM Master Controller function can be combined with a broader range of RTU functions for a Utility Substation. In the substation SCADA application the Master Controller generally shown at 176 communicates with the conductor mounted sensors through transceiver antenna 171. Transmissions from all the conductor mounted sensor modules mounted on each phase of the substation circuits are received as CDMA signals. The sensor modules transmit simultaneously at synchronized time markers provided by the satellite Ultra Small Antenna Terminals (USAT). Each USAT receives its synchronizing GPS time markers distributed by the UltraSatNet Master Hub earth station every second. Current and voltage phasor measurement data can thus be obtained with a time skew below 200 nano-seconds. More than adequate to meet the most stringent relay sequence of events requirements. Signals received from the sensors are demodulated 173, error checked 175, and processed as described for pole-top applications. As before the GPS time markers received from the USAT are transmitted as 900 MHz modulated spread spectrum broadcast signals 174 to all sensors via the 900 MHz transceiver antenna 171. A local display is provided 181, 182 for diagnostic and calibration purposes. Existing substation status 183, interposing relay 184, ambient air/transformer bank temperatures 185, raise/lower control signals 186, pulse-accumulator watt-hour meter 187, and display key-board 188 functions of a typical utility substation RTU are integrated as shown. CPU program and data are stored in flash memory 189 and SDRAM. Any existing CT/PT 190 data from capacitor banks or other diagnostic devices are processed and multiplexed through 191 or directly input to the PLUM Master controller 176 either through a fiber optic LAN interface 192 or Power Line Carrier (PLC) connected to other substation IEDs or through an RS 232 232 port to remote telemetry 195.

The conductor mounted PLUM Sensor Modules and the Master Controller for either Pole-top or Substation applications are referred together in this invention as the PLUM System. The voltage and current phasors are sampled at a rate adequate to determine the highest harmonics of interest. The signals are synchronized throughout the power grid via the GPS derived IRIG B time distribution to all USATs co-located with the sensors or other communication/autonomous GPS patch antenna and timer circuitry. The former being the preferred approach to obtain true snap shots of the power flows at all monitored points of the power grid. Using well known FFT circuitry the PLUM sensor module can generate the true RMS fundamental and harmonic components of the current and voltage and hence power quality measurements. The sensor modules also measure the direction of current flow through the Rogowski coil which provides the power line current measurements without saturating.

Power Utilities have long sought a reliable technique for measuring high impedance faults along distribution circuits. This occurs when and insulated distribution conductor is severed and falls to the ground and the conductor insulation produces a high impedance fault whose magnitude appears to substation protection circuitry as load current i.e. no significant fault current to automatically trip conventional relays. The PLUM sensors located on the conductors can store the signature of the load current over say a week and use signature analysis to distinguish between high impedance faults and normal load over-current excursions.

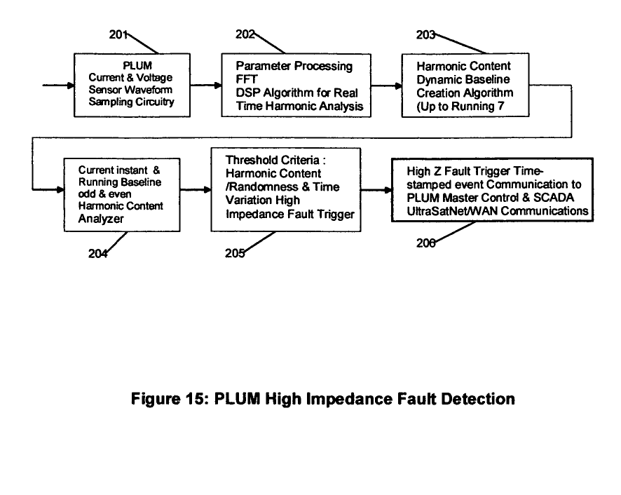

FIG. 15 shows how the conductor mounted PLUMs obtain a dynamic average signature of the normal load current. The sampling circuitry 201 continuously samples the current and voltage waveforms. Real time harmonic analysis 202 is performed using standard parameter processing FFT algorithms employing high speed DSPs or micro-processor controller to obtain the odd-even harmonic content to the highest level required for reliable characterization of the high impedance fault. The sampling rate could be dynamically changed for the harmonic content analysis when the signature analysis produces ambiguous results. The high impedance fault can then be distinguished from the normal load current by comparison of the current harmonic content with the pre-selectable dynamic 7 day average 203 through simple pattern recognition techniques 204 just based on odd-even harmonic content of the current measurement with the seven day baseline. This is done to account for normal load current variations at any instant during an entire week. If required the process can be made more sensitive through adaptive algorithms using high speed Digital Signal Processors (DSPs) and available Al programs. Algorithms in 205 use threshold criteria to distinguish between the high impedance fault and the normal load current. These include the harmonic content, randomness of the real time signal and time variation of the current harmonic content during a high impedance fault. Once the threshold, which can be changed with time, is exceeded the PLUM transmits a high impedance fault trigger 206 to the PLUM Master Controller hardwired to the UltraSatNet two-way USAT satellite communications or other WAN communications network to the SCADA Master/Dispatch Operators desk.

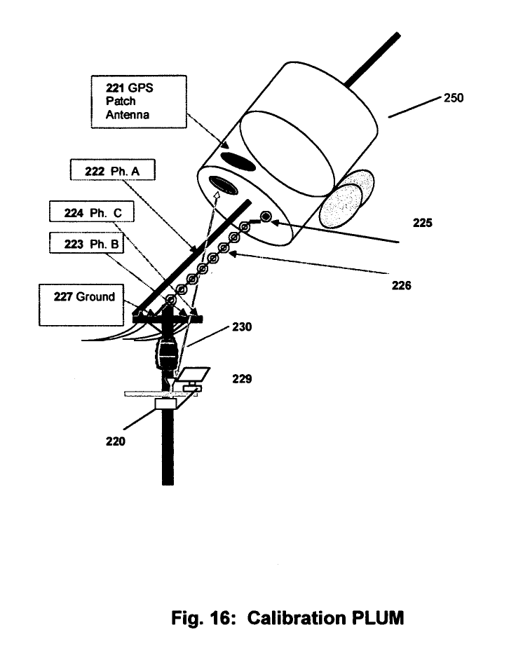

FIG. 16 shows a calibration version of the PLUM generally at 250. GPS patch antenna 221 allows the PLUM to generate an autonomous GPS timing signal without an external IRIG-B or GPS timing pulse over the WAN. The calibration PLUM can be installed on Phase A 222, Phase B 223, or Phase C 224. The calibration PLUM module has a spherical connector 225, attached to the housing through a pass-through grommet port. An external high voltage resistor 226 insulated from the housing is grounded at 227 and connected through the charging current measurement circuitry to the PLUM housing, similar to the capacitor voltage charging current measurement emanating from conductor potential through the housing. This resistive current measurement is directly proportional to the conductor voltage and is an accurate measurement of its potential. It therefore provides an accurate calibration for the PLUM voltage measurement using the self contained hub capacitor at the same location. This voltage calibration factor is communicated to the PLUM Master Controller 220 (shown in block diagram form in all following diagrams with the actual antenna being a low profile patch) located in close proximity to the PLUM via the patch antenna 228. A permanent record of the calibration factor during installation can be communicated by the Master Controller through a hardwired RS 232 port to the USAT 229 to the Power System Control SCADA Master computer over the satellite.

The calibration factor is to a secondary degree affected by whether the adjacent circuit conductors are energized or not. For greater accuracy the adjacent circuit state can be recorded at the time of calibration. Dynamic internal calibration is also accomplished within the regular PLUM sensor module on command from the Master Controller switching the hub capacitor charging current connection to an internal fixed capacitor permanently connected to the Hub conductor contact at one end and on command to the charging current measurement circuitry at the other end. The fixed precision capacitor allows measurement of charging current through it and power conductor while disconnecting charging current from series-parallel hub capacitor. Change in this charging current during operation allows dynamic calibration of the voltage sensor during temporary stray capacitance changes due to various factors. The change in stray capacitance is determined by the change in the precision capacitance baseline measurement.

This can be used to indirectly note any abnormal changes of the stray capacitance to adjust the calibration factor if there is a significant change in stray capacitance due to parked cars or other weather related factors that could have secondary effects degrading metering accuracy. In most cases this could be neglected.

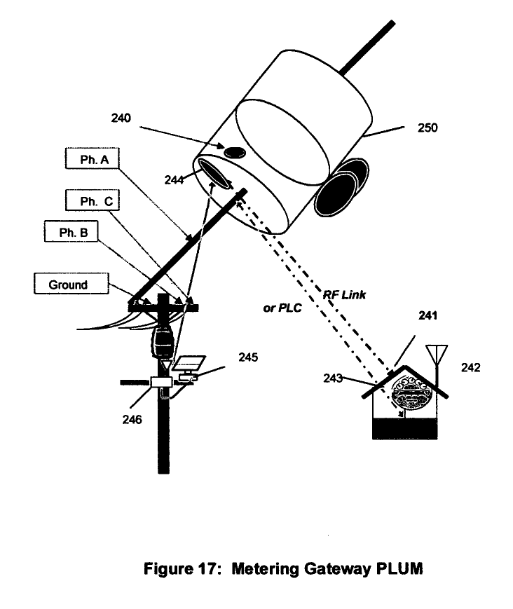

FIG. 17 shows a PLUM module conductor mounted at 250 and in communication through a short haul RF link to a radio transceiver under the meter 241. It could also communicate through an externally mounted RF antenna at 242 connected to the individual customer group meter radio. In this manner the PLUM can communicate to other customer meter radios in a cluster within RF range. The PLUM sensor modules can thus read all the meters in a cluster group as a meter reading data concentrator for re-transmission through the Master Controller to the Customer Meter Reading or Billing Center. The same 2-way RF communications path to the customer meter can be used to download SCADA Master Control Operator commands to drop customer Non-Critical Loads through the PLUM customer meter RF communications link. PLUM communications with the individual customer meter and Non-Critical Load (NCL) control modules can also take place via PLC injection over the phase conductor. The PLUM can thus be used not only for measurement of the line voltage, current and phase parameters but also to perform Automatic Meter Reading and NCL control functions. The onboard PLUM microprocessor can be used to monitor the individual customer loads through the customer meter. The PLUM sensor module transmits the meter data to Master Controller 246 via a two-way RF link 244-246. The Master Controller receives the UltraSatNet GPS synchronizing clock signals meeting IRIG-B accuracy requirements so that PLUM line current, voltage and phase data collection can be a true snap shot with a time skew of about 200 nano-seconds. The PLUM Master Controller can use the same RS 232 port to the USAT to communicate the SCADA data over the wide area satellite network in between transmissions of the metering data. Thus the PLUMs can also be used for accurate phasor measurements of the voltage and current waveforms throughout the power grid.

Instead of the short haul RF link between the PLUM sensor module on the high voltage conductor and the Pole-Top Master Controller an all dielectric fiber optic cable can be used. The fiber optic cable is lashed to the conductor it is mounted on and draped inside an insulator string for adequate BIL creep distance. Standard LED drivers are used for two-way fiber optic communications between each of the PLUM sensor modules and the PLUM Master Controller. This is a recommended solution for locations where RF communications are a problem. This configuration may be particularly suitable if the PLUM System is used for substation bus differential protection scheme, implemented in a similar manner to Transformer Bank differential relay protection without the need to take care of phase shifts and turns ratios involved in the latter.

FIG. 18 shows the PLUM at 250 through the patch antenna 244 has a 2-way RF communications link to the PLUM Master Controller 249 which is connected through an RS 232 port to USAT 245. USAT 245 provides wide area network communications over the satellite to a SCADA Master at the Power System Control Center or a central Billing Center for metering data. PLUM 250 can also communicate with other PLUM sensor modules 251, 252, 253, etc. in communication with customer meter radios. In this manner one USAT WAN node can provide cost-effective two-way communications to 1,000 or more customer nodes. This WAN network can be replicated to cover the entire utility service territory for Distribution Automation, AMR and Demand Response/Load Control. FIG. 18 further shows the inter-PLUM RF/Power Line Carrier PLC) signal can be injected into one of the phases, such as Phase A at 246. The PLUM PLC communications architecture can be used with great flexibility for local customer communications to the Gateway USAT wide area network communications to the Utility SCADA Master or Billing Center in a single hop.

Instead of an RF link a Power Line Carrier (PLC) signal can be injected into one of the phases, such as Phase A at 246. The PLUM at 250 could communicate through the injected PLC to other PLUMs 251 along the same distribution circuit, if needed all the way to the distribution substation supplying power to the feeder. A similar approach can be applied to PLUMs located on Phase B 247 and Phase C 248 injecting digitally addressed PLC signals to other PLUMs on the same feeder or through mode 3 coupling to adjacent phases.

Any ground fault on a power conductor will change the driving point impedance of the faulted phase between the PLUM and ground. By injecting a PLC signal the PLUM could establish the distance to the fault using known impedance calculation or reflected traveling wave techniques between PLUM sensor modules and the fault location.

Differential Protection of a Bus or Transformer Bank

PLUM sensor modules 250 and 251; 252 and 253; 254 and 255 can be installed on the primary and secondary conductor phases on each side of a Transformer Bank or for Substation Bus protection. The turns ratio can be taken into account to match the primary and secondary PLUM sensor measurements of the RMS currents. Under normal conditions the phase A primary current should match the secondary phase A current when the turns ratio and transformer phase shifts are taken into account. Since all sensor modules at the same substation report to the same Master Controller if the primary and secondary currents do not match as when there is an internal transformer fault, the Master Controller would immediately detect a mismatch in current flow between the primary and secondary and the PLUM Master Controller can issue a differential Transformer Bank fault current trip signal. This is similar to the operation of a conventional differential relay using primary and auxiliary current transformer inputs to trip a differential relay during an internal transformer bank fault. This trip signal could be issued within required time for differential fault current detection, generally less than 2 cycles.

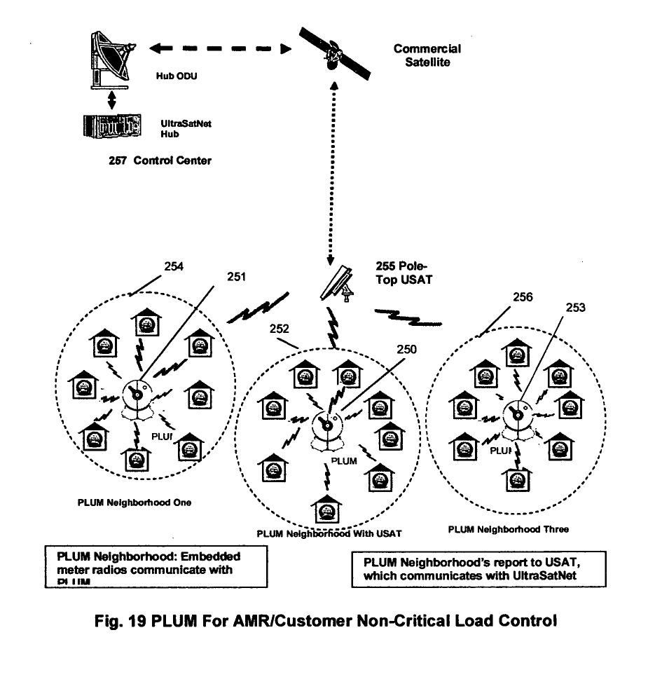

FIG. 19 shows how self-powered PLUMs 250, 251, and 253 on live power conductors can serve as cluster nodes for PLUM Neighborhoods 252, 254 and 256 respectively providing two-way RF communications to individual residential meter radios. This link can be used for Automatic Meter Reading and non-critical load control to reduce power demand by turning off Non-Critical Loads on individual outlets through PLC sub-addressing from the electric meter. In this mode the PLUM at 250 serves to collect data from other PLUMs serving as repeaters. The PLUM at 250 also communicates through the short haul RF link to the USAT at 255. In this manner the USAT at 255 serves as the WAN communication node for all the PLUMs in communication with each other and the customer meter clusters for Automatic Meter Reading (AMR) and load demand control. When demand control commands are received from the adjacent USAT 255 by the PLUM 250 through the RF communication link, this is transmitted to the corresponding cluster PLUMs 254, and 256 in RF communication with the respective meters to implement the load drop command or to read the meters. The load is measured by the meter before and after the command is implemented and this is reported to the Control Center 257 responsible for centralized demand control to avoid rotating blackouts. The UltraSatNet USAT system could implement demand control of interruptible loads in seconds and also report the change in demand after the command is implemented in seconds. The available control response speeds through the combination of UltraSatNet and the PLUM RF links would qualify the available non-critical load control for system spinning reserve saving utilities considerable peaking generator and spinning reserve fossil fuel consumption. The UltraSatNet Hub 257, is in communication with both the utility SCADA Master for Demand Control and the Billing Computer to return Automatic Meter Reads every 15 minutes, on demand, or as needed before and after a load control command is issued. The command to reduce load is received at the Control Center, from the Statewide Regional Operator. Load demand control software calculates the non-critical load to be dropped by each USAT in communication with the Non-Critical Load (NCL) controllers through the PLUMs through RF or PLC communication to the individual customer NCL controllers. The PLUMs relay load drop commands received by the USAT over satellite from the Control Center after reading the meters. After the customer NCL controller drops load the PLUMs issue Automatic Meter Reading commands and report the new meter readings to both the SCADA demand control computers and the Billing Computers. The PLUM contains internal memory to store meter reads, if necessary, until they are all read by the USAT and transmitted to the respective control and billing computers. This is done in the same manner as storage of the harmonic signatures of the individual phase current when used in the fault identification, fault isolation and service restoration mode for high impedance faults. The PLUM architecture allows digital data processing, storage and transmittal over the WAN satellite or terrestrial PLUM RF repeater mode.

Successive PLUM sensor module scans of the customer meters can provide information on whether there has been service interruptions of a specific customer cluster group. This information is transmitted via the PLUM Master Controller and USAT wide area satellite network to the Operator Control Center for service restoration action.

FIG. 20 shows how pole-top capacitor banks at 270 and 281 may be monitored by using a plurality of PLUMs 272 and 283, respectively, in accordance with a preferred embodiment of the present invention. The voltage and VAR information measured by the PLUMs are communicated via the 2-way RF links to USATs 271 and 282 respectively for WAN communication through the satellite to the Control Center 290. This allows efficient coordinated SCADA control of the capacitor banks to maintain the optimum system wide voltage profile, and facilitate maximum tie-transfer capacity without violating system stability constraints. Integration of the PLUM data on a synchronized wide area basis can help prevent rotating blackouts. In the event of a blackout the integrated USAT/PLUM SCADA monitoring and control can help expedite service restoration. If a fault occurs between switches 283 and 285 the fault would be detected by PLUMs 283 and 288. Switch 285 would be opened isolating the faulted section. If the fault occurred between PLUM 288 and switch 286 it would be detected by PLUM 288, the switch/AR 286 would be opened and then switch 277 would be closed through the SCADA link via USAT 276. The faulted segment is isolated and service restored to the unfaulted segments. The PLUMs can be used to detect high impedance faults on the feeder between PLUM at 280 and the Pole-Top cap bank at 270. Similar use is made of the USAT 278, PLUM 279 and normally closed switch 280.

A single UltraSatNet WAN network can thus serve as a multi-function SCADA network for: 1) Substation SCADA automation. 2) Distribution Automation for capacitor voltageNAR control, SCADA pole-top switch or Auto-Recloser controls, fault identification, fault isolation, and service restoration. 3) AMR and Demand Response/Spinning Reserve non-critical load control through two-way communication to individually addressable non-critical load outlets via PLC/RF links.

Utility line crews, for obvious safety reasons, would like visual indication that a pole-switch is physically open if sectionalizing and switch open/close operations are executed remotely via a SCADA link.

FIG. 21 shows how the conductor mounted PLUM sensor 310 with a spherical security type video camera 315 can be used to view the pole switch 313 physical open/close condition, when a SCADA command is sent to the pole switch controller 314 via the USAT 311. The PLUM 310 simultaneously receives an indication of the command through the 2-way RF link 312-316 to the PLUM Master Controller and triggers a snapshot of the pole-switch before and after the command is executed. The line crew can be assured that down stream operations are being conducted safely after positive confirmation that the switch was open and the line current reading was zero. The Master Controller is connected to the USAT through an RS 232 port. The USAT transmits the compressed video snapshots after switch operation to the SCADA Control Center Operator over the wide area satellite network. The PLUM also sends the line current, voltage and status digital data to the Master Controller and via the USAT 311 to the SCADA Master at the Control Center.

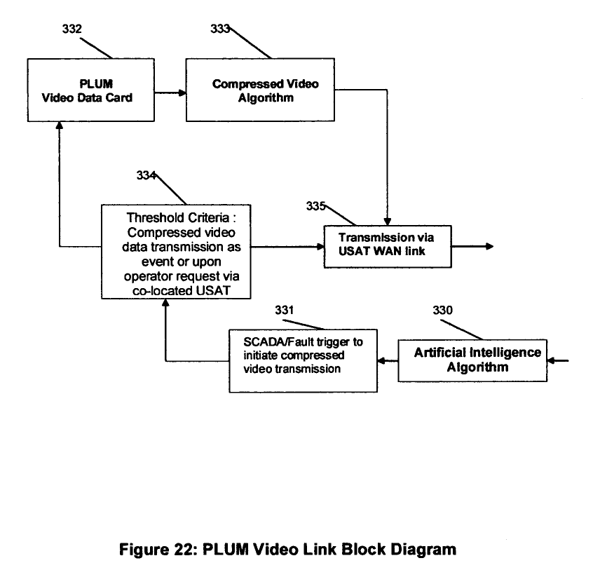

FIG. 22 shows the PLUM video link block diagram. The snap shot of the pole switch is taken either after a SCADA command is issued or the PLUM issues a fault trigger signal to the USAT via the RF link. The video snap shot is also taken if the Artificial Intelligence Algorithm 330 positively identifies a high impedance fault based on threshold criteria 334 and issues a fault trigger 331 through the PLUM RF link to the Master Controller/USAT for communication to the SCADA Control Center. The PLUM takes a video snap shot, the video card 332 processes the image and transmits a compressed video signal 333 via the USAT WAN link 335 to the utility SCADA/ Dispatch Control Center.

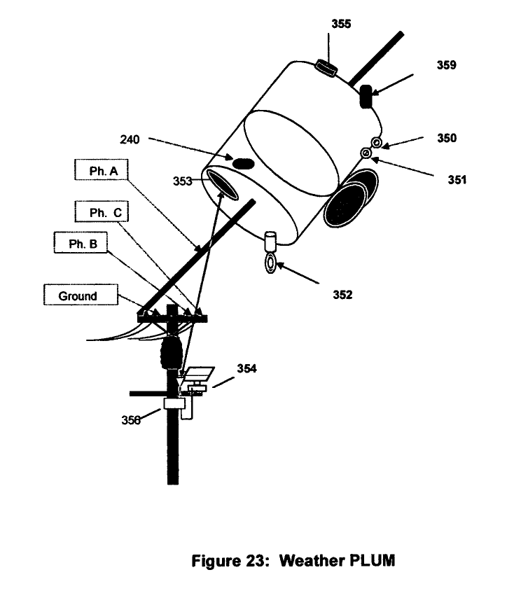

FIG. 23 shows a PLUM weather station sensor module. The high voltage hot-stick conductor-mounted Weather Station PLUM uses a suite of typical environmental sensors for Air Temperature (e.g. IC Chip), Relative Humidity, Wind Speed, Wind Direction, and Precipitation. A Piezzo-electric vibration sensor and digital filter can be used to separate normal or wind induced Aeolian conductor vibrations from earth quake induced vibrations due to ground motion and the traveling S & P-waves from the epicenter. These signals are fed to the A/D converter and processed in a manner similar to the current and voltage analog sensor signals.

Wind Speed sensor 350, Relative Humidity sensor 351, and Wind Direction sensor 352 are used in addition to the PLUM Air Temperature Sensor 355 shown earlier. The Rain Fall sensor 359 completes the suite of micro-weather related sensors. All sensors need to have plastic housings or smooth circular or spherical profiles to prevent corona conditions. The sensor information is processed along with the other power flow analog information and is communicated via RF link 353-356 to the Master Controller with an RS 232 interface to the USAT. The USAT WAN communicates PLUM sensor data to the SCADA Power System Control Center on a routine polling cycle over the satellite network or on an event driven basis depending on set parameter thresholds. The USAT also transfers commands or software uploads from the SCADA Master to the PLUM Master Controller.

Data between the PLUM and Master Controller can be encrypted with other conventional encoders. Each message comprises the latest measured RMS values of voltage and current phasors and another measured auxiliary parameters with a PLUM digital address. Thus, each message format for the fundamental and its harmonics would be repeated as follows:

Sensor Module Identification
4 bits

Auxiliary Parameter No.
4 bits

RMS Voltage
xx bits*

Voltage Phase
xx bits

RMS Current
xx bits

Current Phase
xx bits

Power
xx bits

Reactive Power
xx bits

Harmonic Power Quality Measurements as needed

Auxiliary Parameter
xx bits

Other Sensor Parameters as needed

Cyclic Redundancy Check
xx bits

* Analog parameters can be 16 bit.

The auxiliary parameters can be rotated among each one on successive transmissions, if there are communication bandwidth concerns e.g.

| Parameter No. | Parameter |
|---|---|
| 0 | Check Ground (zero volts nominal) |
| 1 | Check Voltage (1.25 volts nominal) |
| 2 | Sensor Module Interior Temperature |
| 3 | Weather parameters, other |

The individual current, voltage and other analog signals can also be converted through commercially available electro-optic circuitry to optical signals which are transmitted via optical fiber cables to opto-electronic receivers in the pole-mounted Master Controller co-located with a USAT in some locations. In the case of an opto-electronic system the voltage and current sensors could be optical transducers using the Hall and Pockels tranducer effects. However, the accuracy is dependent on conductor vibration effects and variations in conductor sag with temperature. The PLUM sensor module according to the present invention is free from such inaccuracies and high cost to overcome such problems.

A 7-30 kHz power line carrier (PLC) signal can be pulse code modulated, for example, by mode 3 coupling, as shown, through the transformer bank neutral feeding the substation buses and hence the circuits to be monitored as previously described by the current inventor. The PLC signal is detected by an inductive pick-up on the split core of the sensor module 10. The signal is filtered by a low-pass filter, to remove 60 Hz components of the power line and demodulated.

If the transceiver sensor modules are to be mounted on insulated distribution conductors, a special hub is used having sharp metal protrusions extending from hub inner ring to pierce the conductor insulation and to provide a conducting path between the inner ring and the conductor. Alternatively, a bucket crew using rubber gloves could mount the sensor module over a stripped portion of the conductor for distribution circuits.

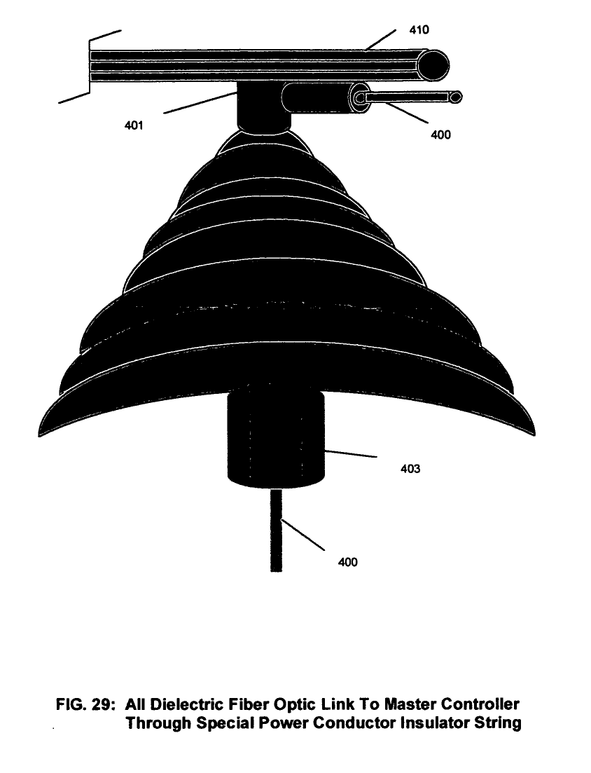

FIG. 29 shows how a Fiber Optic Cable link is used between the PLUM and the Master Controller. An all dielectric fiber optic cable 400 is connected to the PLUM I/O RS 232 Opto-Electronic Driver commercially available from a large number of commercial sources and replaces the RF communications link 117. Entry of the fiber optic cable 400 is made through 401, an all dielectric entry port through the insulator string. It is lashed to the Power Conductor 410 in a manner similar to a Telco installation using a messenger wire, except that the Power Conductor acts as the messenger support. The fiber optic cable 400 exits the Power Conductor Insulator String through a vertical all dielectric pass through 403 and interfaces with the Master Controller RS 232 connection through a commercially available opto-electronic module.

The PLUM invention as disclosed shows how the objects of the invention are met. It must be noted that the environment of a high voltage conductor are unique. In the presence of high EMI (electromagnetic interference) levels and E-field voltage gradients the unique configuration used for the sensors is dictated by the environment on the high voltage conductor. While voltages and currents have been measured for decades at ground potential level, the conventional methods to measure high voltage, a high voltage circuit current, power factor and phasors of voltage and current have been separately made and have involved huge Potential Transformer bushings for isolation from ground and large Current Transformer bushings. The present invention eliminates the need for all the expensive porcelain bushings, individual primary PTs and CTs, auxiliary PTs and CTs, and transducers and test switches in the substation control house or on a pole-top. It does all of this and replaces tons of equipment by a single conductor mounted PLUM sensor module and Master Controller providing metering grade accuracy for all parameters, namely voltage, current, corresponding phasors, power factor, Power and Reactive Power. Furthermore, the manner in which all these parameters are synchronized across the grid to obtain a true snapshot of the grid, never attained in the past, is also disclosed. The wireless separation of the quantities that need to be measured on the power conductor are done so without the disadvantage of propagating lightning transients from the high voltage transmission line to the substation control house. Elimination of all the primary and auxiliary wiring eliminates the distortions of the true magnitude and phase of the actual line flows. This is particularly true when transients associated with the parameters to be measured, such as fault currents, lightning transients, and high voltage line switching surges are to be measured. Calibration of the parameters is performed without the need to de-energize the high voltage power circuit, unlike alternative measurement techniques. The proposed invention also overcomes the high cost, errors due to power conductor sag, and effects of vibration on the accuracy of purely optical current and voltage sensing measurement techniques. The PLUM ensures that high voltage corona effects, environmental effects on convention high voltage capacitive coupled voltage transformers and the hazards of Primary Potential transformer PCB insulating fluids are also eliminated.

The RF transmissions are made more reliable through a grounding capacitor between the transceiver antenna and the power conductor. The unique cylindrical split hub capacitor that would work accurately in an outdoor high voltage conductor environment and integral to the PLUM sensor module housing itself has never been successfully manufactured or disclosed prior to the current invention. Much less in a manner that would be self calibrating and providing metering grade accuracy for all the parameters measured in the context of wide area high voltage power system control for maximum stability and power transfer.

What is claimed is:

1. A Power Line Universal Monitor (PLUM) sensor module for installation on and removal from an energized High Voltage AC power conductor for accurately measuring Global Positioning Satellite (GPS) synchronized voltage, current, phase, frequency and derived quantities on said AC power conductor, said PLUM comprising:
a plurality of sensors for make GPS synchronized measurements of said conductor voltage, current, phase, frequency and derived fundamental and harmonic quantities simultaneously at a plurality of predetermined times determined by the utility Wide Area Network Supervisory Control And Data Acquisition (SCADA) and Relaying application requirements;
an RF signal transmitter for transmitting said measurements to a Master Controller using a secure two-way RF signal;

2. The PLUM of claim 1 further comprising:
a metallic housing mounted in surrounding relation to and conductively isolated from the associated conductor, and
a plurality of hub capacitors for series-parallel connection, shielded from the environment in the hub space surrounding the high voltage AC power conductor, whereby a charging current is present on said housing due to the electric field of said high voltage AC power conductor and wherein said conductor voltage is measured by sensing a charging current through said plurality of hub capacitors.

3. The PLUM of claim 2 further comprising:
a switch for bypassing charging of said hub capacitors; and
a calibration sensor module with charging current measurement circuitry for accurately measuring current through a known precision high voltage resistance to ground, in order to account and calibrate for the influence of adjacent conductors and stray capacitances at the time of installation.

4. The PLUM of claim 2 further comprising a fixed precision capacitor for measuring charging current through said high voltage AC power conductor while disconnecting charging current from the series-parallel hub capacitors, wherein a measured change in this charging current during operation allows dynamic calibration of the PLUM sensor during temporary stray capacitance changes due to various factors.

5. Invention according to claim 2 wherein said PLUM sensor further includes
a processor for accurately calculating the phase of each of said measurements at the high voltage AC power conductor while accurately retaining phase relationships between said measurements through GPS time synchronization.

6. A system for monitoring and controlling an energized high voltage power conductor at conductor potential and detecting possible high impedance faults, and pole-top auto-recloser operations, said system comprising:
a sensor module for mounting upon and removal from said energized high voltage power conductor, said sensor module having
sampling circuitry for sampling the value of a variable parameter and determining the fundamental and harmonic content of said variable parameter, said sensor module further including a memory for storing the sampled value over selectable intervals of time (ranging from hours to days), in order to establish a harmonic signature and transient random variation for said variable parameter;
a processor for monitoring changes in the stored harmonic signature of said variable parameter in order to determine the presence of a high impedance fault; and
a transmitter for transmitting a fault trigger in response to said changes in the stored harmonic signature;
a ground receiver, remote from said sensor module for receiving said fault trigger and actuating a control means in response thereto.

7. The system of claim 6 wherein said transmitter transmits said fault trigger over a wide area network communications link using secure Code Division Spread Spectrum Multiple Access communications.

8. The system of claim 6 wherein the sampling circuitry for sampling the value of a variable parameter includes circuitry for varying the interval of time over which said sampling occurs, such that the sensor module may sample over longer and/or shorter time intervals in response to said parameter exhibiting an abnormal variation of the harmonic signature.

9. The system of claim 6 wherein the sensor module further includes circuitry for detecting and recording the total number of open/close operations of an auto-recloser switch coupled to said high voltage power conductor, said total number of open'close operations being transmitted to a power grid control operator.

10. The system of claim 6 wherein said control means includes a relay actuator for interrupting the high voltage power supply.

11. The system of claim 6 wherein said transmitter is comprised of a fiber optic communications link.

12. The system of claim 8 wherein the number of samples taken over an interval of time is also variable in response to a predetermined rate of change of said parameter harmonic content.

13. The system of claim 8 wherein said sampling circuitry is constructed and arranged to sample at least one or more harmonics of said variable parameter, and wherein said sampling interval of time is adequate to measure the highest desired harmonic content in order to distinguish a high impedance fault from normal load over-current.

14. The system of claim 9 wherein said operator alarm comprises a remote telemetering interface for communicating a fault trigger alarm signal to a location remote from said ground receiver.

15. A system for fault detection, fault isolation, determination of sequence-of-events and service restoration, across a power grid, said system comprising:
a plurality of sensor modules for mounting upon and removal from each of the energized high voltage AC conductors within the power grid; each of said sensor modules in the plurality comprising:
GPS time level synchronization circuitry for causing said each of said sensor modules in the plurality to simultaneously measure fault indicating parameters on each of their associated high voltage AC conductors;
a transmitter for transmitting signals from said sensor module commensurate with measurement of the fault indicating parameter;
a remote controller separate and remote from the plurality of sensor modules, for receiving and comparing said signals all within the time constraints required for effective power grid protection; and
a processor to generate a relay control signal for operating an automated switch or circuit breaker in response to a detected difference between said compared signals exceeding a predetermined threshold level.

16. The system of claim 15 wherein said time constraints comprise a time period not greater than that of 2 successive cycles of current when used for differential protection of a power grid substation transformer.

17. The system of claim 15 wherein said remote controller further includes a transmitter for transmitting time-synchronizing signals to each of said sensors in the plurality, each of said modules including a receiver for receiving said time-synchronizing signals, each of the modules in the plurality then measuring said fault indicating parameter at times established by said time-synchronizing signals.

18. The system of claim 17 wherein said time-synchronizing signals are transmitted as RF signals.

19. The system of claim 17 wherein said time-synchronizing signals are transmitted using power line carrier injection.

20. The system of claim 17 wherein said time-synchronizing signals are transmitted via fiber optic communication links.

21. A system for providing differential relay protection of a bus or primary substation power device through wireless sensing of current differential on at least one pair of electrical conductors carrying current to and from, respectively, said bus or primary substation power device, the system comprising:
at least a pair of sensor modules, one of such sensor modules mounted upon each of the conductors in the at least one pair for measuring the current flowing through said conductor; wherein each sensor module includes:
control and timing circuitry for causing all of said modules in the at least one pair to measure the analog current on its associated conductor simultaneously;
a transmitter for transmitting signals from said modules commensurate with the current measured thereby;
a master controller having:
a receiver for receiving said signals;
a processor for comparing said signals received from each of the modules on each of the conductors; and
a processor to generate a substation control relay signal which is operated in response to a detected difference between said compared signals exceeding a predetermined threshold level to protect said bus or primary substation power device.

22. An integrated system for performing metering, monitoring and control functions at a high voltage power substation, power grid pole-top capacitor banks and auto-recloser switch locations, said system comprising:
a plurality of individual sensor modules each of said sensor modules in the plurality being removeably mounted upon a high voltage AC power conductor at said substation, each of said modules including:
sensing circuitry for simultaneously measuring each of a plurality of variable parameters, including voltage and current, power and reactive power associated with operation of said conductor upon which it is mounted;
timing and control circuitry for GPS time-synchronizing the measurement of said parameters by said plurality of modules, whereby each of said modules measures the value of the same parameter at the same time on its associated conductor;
a transmitter for transmitting signals commensurate with the values of said parameters measured by said modules;
a Master Controller having:
a receiver for receiving said signals from each of said sensor modules;
a processor for processing said signals from each of said sensor modules and generating a set of digital signals in response thereto,
a transmitter for sending said digital signals over a wide area communications network for performing metering, monitoring and control functions at corresponding sensor module locations.

23. The integrated system of claim 22, wherein the Master Controller can also receive substation control/status and conditioning signals from existing current and potential transformers, process the values of said signals and generate a set of digital control signals in response thereto.

24. The integrated system of claim 22 wherein said Master Controller is further comprised of alarm status monitoring circuitry, for detecting a fault status and performing select-before-operate control functions through interposing relays, or generating pulse control signals.

25. The integrated system of claim 22 wherein said Master Controller further includes means for establishing whether each of the conductors of said first plurality is energized, and means for selecting an appropriate scale factor to be applied to a voltage reading from each of said sensor modules in accordance with the energized state of adjacent conductors determined by calibration at the time of installation.

26. The integrated system of claim 22 wherein said Master Controller can transmit the voltage and reactive power at said power grid pole-top capacitor bank location for operator control over the wide area SCADA network.

27. A system for monitoring a plurality of parameters associated with each of a plurality of energized electrical power conductors of a power delivery network over the full operating range from minimum to maximum conductor current, said system comprising:
a plurality of sensor modules for complete installation and removal while said conductors are energized, each one of said modules being mounted upon one of said energized electrical conductors; each of said sensor modules in the plurality having:
circuitry for sensing and measuring values for any of a plurality of parameters of the associated power conductor upon which said sensor module is mounted;
timing and control circuitry for synchronizing the measurements with GPS level timing accuracy such that each sensor module can measure any of the plurality of parameters at the same time;
a processor for identifying, manipulating and processing said sensed and measured values in order to generate encoded signals;
a transmitter for periodically transmitting time-synchronized sequences of said encoded signals in bursts of predetermined duration;
means carried by each of said modules for controlling the starting times of said data bursts by said transmitting means using direct sequence code division spread spectrum multiple access 2-way communication links for simultaneous transmissions from multiple sensor modules;
a remote master controller, remote from said modules, for receiving said encoded signals from each of said plurality of modules and decoding said signals to provide said sensed and measured parameter values in order to derive from said values operational status information, including normal, abnormal and transient operating conditions, about said power conductors, in order to synchronize control of said power delivery network over said full operating range during all of said normal, abnormal and transient operating conditions, in accordance with said operational status information.

28. A method of monitoring and controlling a power delivery network having a plurality of power conductors over the full operating range from minimum to maximum conductor current, said method comprising:
removeably mounting a plurality of sensor modules upon the plurality of power conductors while said conductors are energized, each one of said modules being mounted upon one of said energized electrical conductors;
using said plurality of sensor modules to sense and measure values for any of a plurality of parameters of the associated power conductor upon which said sensor module is mounted;
synchronizing said sensing and measuring by each of the sensor modules in the plurality with GPS level timing accuracy such that each sensor module can measure any of the plurality of parameters at the same time;
identifying, manipulating and processing said sensed and measured values in order to generate encoded signals;
transmitting time-synchronized sequences of said encoded signals in bursts of predetermined duration using direct sequence code division spread spectrum multiple access 2-way communication links for simultaneous transmissions from multiple sensor modules;
receiving said encoded signals from each of said plurality of modules and decoding said signals to provide said sensed and measured parameter values in order to derive from said values operational status information, including normal, abnormal and transient operating conditions, about said power conductors, in order to synchronize control of said power delivery network over said full operating range during all of said normal, abnormal and transient operating conditions, in accordance with said operational status information.

29. A high voltage conductor mounted sensor module provides metering grade high voltage, current, and phase angle measurement accuracy, remote customer meter reading gateway functions and comprises:
a metallic housing mounted in surrounding relation to and conductively isolated from an associated high voltage conductor in a plurality of high voltage conductors, whereby a charging current is present on said housing due to the electric field of said associated high voltage conductor;
charge current sampling circuitry for sensing voltage proportional to said charging current;
conductor current sensing and sampling circuitry for measuring conductor current through said high voltage conductor;
a processor for accurately determining voltage and current phase angles simultaneously using GPS time markers at the same point in time for both the sampled current and voltage, and determining power factor, real and reactive power, and frequency means for data concentration of meter reads from a cluster of customer meters for re-transmission ; and
a transmitter for transmitting the measured values for said voltage, conductor current as well as the determined voltage and current phase angles, power factor, real and reactive power flow, frequency, and customer meter data from a cluster group to a Master Controller using secure direct sequence two-way Code Division Spread Spectrum Multiple Access Communications

30. The high voltage conductor mounted sensor module as in claim 29, wherein said current sampling circuitry for sensing the charging current is comprised of corona shielded, multiple series-parallel hub capacitors which are electrically coupled to the high voltage conductor.

31. The high voltage conductor mounted sensor module as in claim 29 wherein the influence of adjacent conductors in the plurality, and stray capacitances, is accounted for through a calibration sensor module comprising:
an electronic switch for electrically coupling the current sampling and measurement circuitry to a known high voltage resistance to ground thereby bypassing the charging current from the multiple hub capacitors connected in parallel from flowing through said measurement circuitry;
processing means for accurately calculating a voltage proportional to the resistive current measured by the current sampling and measurement circuitry when the switch is activated; wherein said processing means includes a scale factor responsive to energized or de-energized state of each of said adjacent conductors and determined during calibration.

32. The high voltage conductor mounted sensor module as in claim 30, further comprising
an electronic switch for electrically coupling a fixed precision capacitor to said high voltage power conductor in order to measure the current through the precision capacitor while disconnecting the series-parallel hub capacitors from said high voltage power conductor, wherein a change in this precision capacitor current during operation allows dynamic calibration of the voltage sensing circuitry during temporary stray capacitance changes due to various factors.

33. The high voltage conductor mounted sensor module as in claim 30 wherein said voltage and current sampling circuitry includes sensors which surround the high voltage conductor in separate planes to allow single hot stick conductor mounting without violating conductor clearances and allowing maximum hub capacitance in shielded area free from direct precipitation effects.

34. The high voltage conductor mounted sensor module as in claim 30 further comprising GPS timing circuitry which allows for synchronized current and voltage measurements.

35. The high voltage conductor mounted sensor module as in claim 30 wherein the transmitter is an RF communication link within a wide area communication network which utilizes code division spread spectrum multiple access around GPS time markers for hacker free RF communications between the sensor module and the Master Controller.

36. The high voltage conductor mounted sensor module as in claim 30 further comprising:
a spherical video cam for taking a video snap shot of the pole switch prior to and after executing an open/close SCADA command; and
a video processor for compressed video processing and transmission of said pole switch video snap shot.

37. The high voltage conductor mounted sensor module as in claim 30 further comprising circuitry for determining the harmonic content and transient randomness of the harmonic content of voltage and current signals through the high voltage conductor for high impedance fault identification.

38. The high voltage conductor mounted sensor module as in claim 30 further comprising environmental sensors for measuring the conductor temperature, ambient air temperature, relative humidity, wind speed and wind direction

39. The high voltage conductor mounted sensor module as in claim 30 co-located at distribution voltage pole-top switches to detect faulted feeder sections, transmit such information through the Master Controller to allow a Control Center Operator to isolate the faulted segment and restore service to unfaulted sections within seconds.

40. The high voltage conductor mounted sensor module as in claim 39, wherein said Master Controller receives the signals transmitted from the sensor module, processes said signals, and transmits GPS synchronizing command control signals back to the sensor module in order to control further operations of said sensor module.

41. The high voltage conductor mounted sensor module as in claim 40, wherein said Master Controller receives data from a group of several customer meters for re-transmission via a USAT wide area communications network to a Customer Billing Center.

42. The high voltage conductor mounted sensor module as in claim 41 wherein said Master Controller can download commands from the Control Center Operator via the USAT wide area network to said conductor mounted sensor for re-transmission to the customer meter for power demand control.

43. The high voltage conductor mounted sensor module according to claim 42 that can compare total meter reading demand of the customer group in communication with it to detect interruption of service based on successive customer group meter reading scans.

44. A high voltage conductor mounted sensor for detecting earth quake vibrations, comprising:
a metallic housing mounted in surrounding relation to and conductively isolated from the associated conductor, upon which it is mounted;
a piezzo electric transducer for detecting conductor vibrations and representing them in the form of an electrical signal;
memory for storing the electrical signal which represents said measured conductor vibrations as a dynamic record over pre-selectable intervals;
processing means for calculating the magnitude and frequency of said electrical signal; and
filtering means for digitally filtering out wind portions of said electrical signal which represent wind induced vibrations from earthquake induced vibrations by filtering out those portions of the signal which fall outside the earthquake frequency band.

45. The high voltage conductor mounted sensor of claim 44, further comprising:
a transmitter for transmitting the filtered electrical signal which represents detected earthquake induced vibrations to a Master Controller, wherein said Master Controller receives said transmitted signals in digital form and further transmits GPS synchronized multiple sensor module earth quake detection signals over a wide area communications network or USAT satellite network.
